(19) United States
(12) Patent Application Publication
(10) Pub. No.: US 2026/0303384 A1
(43) Pub. Date: Oct. 1, 2026

(54) STRUCTURED ENGAGEMENT EXCHANGE PLATFORM

(71) Applicant: XBT Foundry, Inc., Palo Alto, CA (US)

(72) Inventors: Gregory J. Wolff, Palo Alto, CA (US); Benjamin Martin Bly, Ann Arbor, MI (US)

(21) Appl. No.: 19/631,175

(22) Filed: Mar. 27, 2026

Related U.S. Application Data
(60) Provisional application No. 63/778,532, filed on Mar. 27, 2025.

(51) Int. Cl. H04L 9/00; H04L 9/32

(52) U.S. Cl. CPC H04L 9/50; H04L 9/3234

(57) ABSTRACT

A distributed computing system and method for facilitating programmable value exchange, multi-party engagements, and secure multi-agent coordination. The system utilizes a distributed trust network anchored by a cryptographically secured registry that validates accountable host nodes and governs the issuance of asset-backed digital credits. Host nodes instantiate digital engagements from immutable cryptographic templates, maintaining verifiable state transitions on dedicated, append-only hash chains. System trust is established via staking mechanisms, requiring entities to cryptographically lock digital assets to participate. Engagement conclusion, token minting, and stake redistribution are executed contingent upon multi-party cryptographic consensus signaling.

### CROSS REFERENCE TO RELATED APPLICATIONS

This application claims the benefit of U.S. Provisional Patent Application No. 63/778,532, titled “Method for Tracking and Rewarding Engagements Using experience Based Tokens,” filed Mar. 27, 2025, the entire contents of which are herein incorporated by reference.

### BACKGROUND

In transaction-based systems, the relative value of goods and services is highly visible. Users utilize price as a zero-sum signal of value transfer, where the buyer pays and the seller receives. However, many digital and real-world interactions involve a collaborative approach that relies on mutual effort from multiple participants to achieve some shared objectives and create value. Because this mutual effort and resulting value are not easily visible or quantifiable, users can face significant technical hurdles when attempting to evaluate the reliability of a potential engagement, discover valuable collaborative opportunities, or establish verifiable trust with other users.

This background description provided herein is for the purpose of generally presenting the context of the disclosure.

### SUMMARY

The present disclosure describes techniques relating to distributed computing systems for managing and coordinating collaborative structured engagements involving multiple participants. In particular, the techniques introduced herein describe a system and method for implementing a cryptographic mechanism for immutably tracking the digital identities, mutual commitments, and verifiable trust of multiple participants through a sequence of interactions within the collaborative structured engagements. One of the techniques that may be implemented for facilitating collaborative structured engagements is either adopting fully centralized architectures (introducing single points of failure and requiring total surrender of asset custody) or fully decentralized, zero-trust permissionless blockchains (which lack accountability, verifiable identity, and dispute recourse mechanisms).

The present disclosure of the cryptographic mechanism for managing and coordinating collaborative structured engagements involving multiple participants provides a technical improvement by building a distributed trust network anchored by a registry of accountable HOST nodes. The present disclosure is particularly advantageous because this structural topology enables lowest-common-denominator dispute resolution, allowing parties to a structured engagement to cryptographically route disputes through overlapping trusted HOSTs, thereby significantly reducing the computational and administrative overhead of dispute resolution without requiring a singular, monolithic adjudicator. The present disclosure further provides a technical improvement by configuring the system to utilize cryptographic staking as the fundamental structural action authorizing network activity instead of relying on arbitrary administrative permissions. This can ensure that authority over a data structure (e.g., an engagement or template) requires a verified transfer of digital credits. Furthermore, concluding an engagement defaults to mutual cryptographic consensus signaling. The present disclosure is highly advantageous because it forces all actors in the distributed trust network to maintain verifiable economic commitment, thereby virtually eliminating zero-cost malicious actions (e.g., spam) and preventing unilateral value extraction by any single party.

The present disclosure of the cryptographic mechanism for managing and coordinating collaborative structured engagements involving multiple participants provides a technical improvement by replacing subjectively reported user trust ratings with a deterministic approach where the present disclosure computes trust and reliability metrics of accounts and entities in the distributed trust network from immutable, cryptographically verified on-chain data, such as locked digital stake and engagement conclusion records. The present disclosure is particularly advantageous because the resulting trust and reliability metrics can provide an objective, positive-sum signal that accurately reflects collaborative value creation, thereby neutralizing the technical vulnerabilities of fake reviews, subjective bias, and reputation manipulation. Additionally, software agents powered by artificial intelligence are configured to operate independently in their interaction with their users, where they lack the ability to seamlessly interact in shared collaborative states or other software agents without compromising local data privacy. The present disclosure provides a technical improvement by surfacing a shared context of an engagement involving multiple participants by securely inviting their software agents to participate in the engagement and advantageously allowing them to continuously poll the shared context for “ground truth” and then contribute updates to the engagement's hash chain on their user's behalf, all while strictly preserving the boundaries of their user's private local context and data.

The present disclosure relates to method and system for implementing a cryptographic mechanism for managing and coordinating collaborative structured engagements involving multiple participants. According to one aspect of the subject matter described in this disclosure, a method includes: instantiating an engagement including a first user and a second user based on a template, maintaining a shared context associated with the engagement, wherein the shared context includes a first contextual element associated with the first user in the engagement, receiving a request to invite a first autonomous agent associated with the second user to participate in the engagement, sending, in response to the request, a prompt including a unique identifier of the engagement and a first authentication code to a resource identifier of the first autonomous agent, providing the first autonomous agent with access to the shared context associated with the engagement based on validating the first authentication code, the first autonomous agent configured to consult a private context associated with the second user and determine a second contextual element from the private context that corresponds to the first contextual element, receiving a submission of the second contextual element from the first autonomous agent, and updating the shared context associated with the engagement with the second contextual element.

In general, another aspect of the subject matter described in this disclosure includes a system comprising one or more processors and memory operably coupled with the one or more processors, wherein the memory stores instructions that, in response to the execution of the instructions by one or more processors, cause the one or more processors to perform operations. The operations include: instantiating an engagement including a first user and a second user based on a template, maintaining a shared context associated with the engagement, wherein the shared context includes a first contextual element associated with the first user in the engagement, receiving a request to invite a first autonomous agent associated with the second user to participate in the engagement, sending, in response to the request, a prompt including a unique identifier of the engagement and a first authentication code to a resource identifier of the first autonomous agent, providing the first autonomous agent with access to the shared context associated with the engagement based on validating the first authentication code, the first autonomous agent configured to consult a private context associated with the second user and determine a second contextual element from the private context that corresponds to the first contextual element, receiving a submission of the second contextual element from the first autonomous agent, and updating the shared context associated with the engagement with the second contextual element.

Furthermore, in some implementations, the operations include creating a subaccount associated with the first autonomous agent under an account of the second user, authorizing a public key of the subaccount associated with the first autonomous agent using a private key of the account of the second user to participate in the engagement on behalf of the second user, and receiving the submission of the second contextual element from the first autonomous agent through an authorized signature of the first autonomous agent. Also, in some implementations, the operations include receiving a request to invite a second autonomous agent associated with the first user to participate in the engagement, sending, in response to the request, a prompt including the unique identifier of the engagement and a second authentication code to a resource identifier of the second autonomous agent, and providing the second autonomous agent with access to the shared context associated with the engagement based on validating the second authentication code, the second autonomous agent configured to consult a private context associated with the first user to determine the first contextual element. Moreover, in some implementations, the first contextual element is generated based on an interaction between the first user and the second autonomous agent in the private context associated with the first user, and the second contextual element is generated based on an interaction between the second user and the first autonomous agent in the private context associated with the second user. Also, in some implementations, the operations include receiving a request from the first user to instantiate the engagement based on the template, generating a genesis entry using a current cryptographic head of an independent hash chain associated with the template, computing the unique identifier of the engagement by executing a cryptographic hash function on the genesis entry, and initiating an independent hash chain associated with the engagement by appending the genesis entry. Furthermore, in some implementations, the operations include receiving a first digital stake from an account of the first user to the unique identifier of the engagement, and receiving a second digital stake from an account of the second user to the unique identifier of the engagement, where the first digital stake and the second digital stake serve as an enforcement mechanism for participation in the engagement and remain locked until the engagement transitions to a concluded state. Additionally, in some implementations, the operations include receiving a submission of an authorized entry to the independent hash chain associated with the engagement from the first autonomous agent associated with the second user, the authorized entry indicating a readiness to conclude the engagement, verifying the authorized entry satisfies machine-executable conclusion criteria defined by the engagement, determining a mint cost associated with a token to be minted in the engagement, verifying that a sum of the first digital stake and the second digital stake is sufficient to cover the mint cost, minting the token by deducting the mint cost from an account of the engagement, distributing the token to the second user for participation in the engagement, and transferring a remainder of the sum of the first digital stake and the second digital stake to one or more of the first user and the second user. Moreover, in some implementations, the private context associated with the second user is inaccessible to the shared context associated with the engagement and the first user. Additionally, in some implementations, an update to the shared context associated with the engagement corresponds to an entry cryptographically posted to an independent hash chain associated with the engagement. Furthermore, in some implementations, the first user is a healthcare professional, the second user is a patient member, and the engagement corresponds to a sequence of interactions between the first user and the second user in a healthcare intervention.

Other implementations of one or more of these aspects and other aspects include corresponding systems, apparatus, and computer programs, configured to perform the various action and/or store various data described in association with these aspects. Numerous additional features may be included in these and various other implementations, as discussed throughout this disclosure.

The features and advantages described herein are not all-inclusive and many additional features and advantages will be apparent in view of the figures and description. Moreover, it should be understood that the language used in the present disclosure has been principally selected for readability and instructional purposes, and not to limit the scope of the subject matter disclosed herein.

### BRIEF DESCRIPTION OF THE DRAWINGS

The techniques introduced herein are illustrated by way of example, and not by way of limitation in the figures of the accompanying drawings in which like reference numerals are used to refer to similar elements.

FIG. 1 is a high-level block diagram illustrating one implementation of an example system for implementing a cryptographic mechanism for managing and coordinating collaborative structured engagements involving multiple participants.

FIG. 2 is a block diagram illustrating one implementation of an example computing device including a structured engagement application.

FIGS. 3A-3E illustrate graphical representations of example user interfaces for navigating one or more engagements on a secure engagement exchange platform.

FIG. 4 is a flow diagram illustrating one implementation of an example method for staking a digital credit on a template.

FIG. 5 is a flow diagram illustrating one implementation of an example method for staking a digital credit on an engagement from a template.

FIG. 6 is a flow diagram illustrating one implementation of an example method for staking a digital credit on an invite to an engagement.

FIG. 7 is a flow diagram illustrating one implementation of an example method for concluding an engagement.

FIG. 8 is a flow diagram illustrating one implementation of an example method for coordinating with an autonomous agent in an engagement.

### DETAILED DESCRIPTION

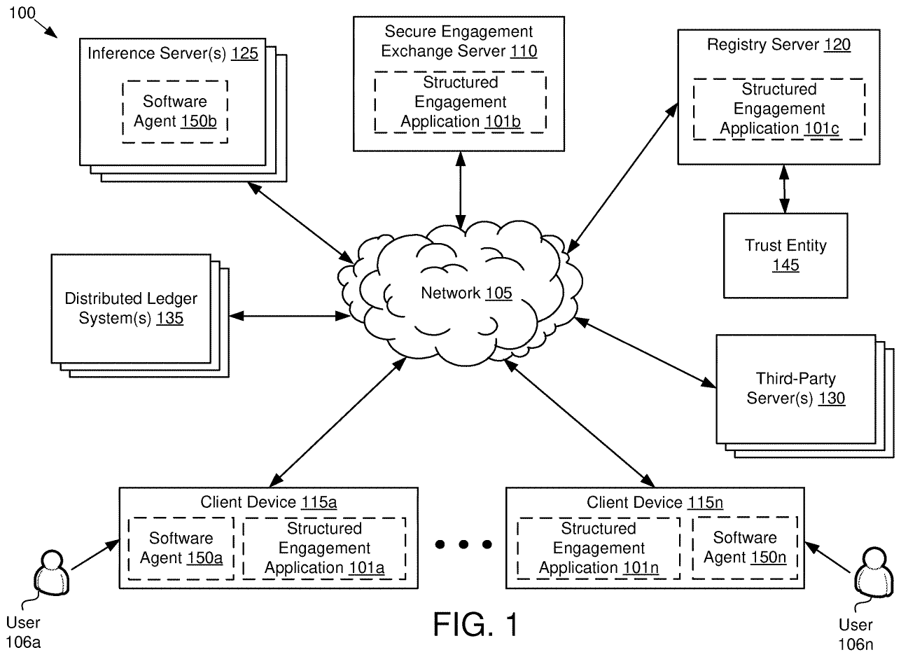

FIG. 1 is a high-level block diagram illustrating one implementation of an example system 100 for implementing a cryptographic mechanism for managing and coordinating collaborative structured engagements involving multiple participants. The illustrated system 100 may have one or more client devices 115a . . . 115n that can be respectively accessed by one or more users 106a . . . 106n, a secure engagement exchange server 110, a registry server 120, one or more inference servers 125, one or more third-party servers 130, and one or more distributed ledger systems 135. In FIG. 1 and the remaining figures, a letter after a reference number, e.g., “115a,” represents a reference to the element having that particular reference number. A reference number in the text without a following letter, e.g., “115,” represents a general reference to instances of the element bearing that reference number. In the illustrated implementation, these entities of the system 100 are communicatively coupled via a network 105 for interaction and electronic communication with one another. While one implementation of the functionality of the system 100 is described below with reference to the client-server architecture shown in FIG. 1, it should be understood that the functionality of the system 100 may be implemented in other architectures. For example, in some implementations, the system 100 may be configured on a single computer (or virtual machine) coupled to the network 105 to provide a loopback communication using Transmission Control Protocol (TCP) or sockets.

The network 105 may be a conventional type, wired or wireless, and may have numerous different configurations including a star configuration, token ring configuration, or other configurations. Furthermore, the network 105 may include any number of networks and/or network types. For example, the network 105 may include a local area network (LAN), a wide area network (WAN) (e.g., the Internet), virtual private networks (VPNs), mobile (cellular) networks, wireless wide area network (WWANs), WiMAX® networks, Bluetooth® communication networks, peer-to-peer networks, near field networks (e.g., NFC, etc.), and/or other interconnected data paths across which multiple devices may communicate, various combinations thereof, etc. The network 105 may also be coupled to or include portions of a telecommunications network for sending data in a variety of different communication protocols. In some implementations, the network 105 may include Bluetooth communication networks or a cellular communications network for sending and receiving data including via short messaging service (SMS), multimedia messaging service (MMS), hypertext transfer protocol (HTTP), direct data connection, WAP, email, etc. In some implementations, the data transmitted by the network 105 may include packetized data (e.g., Internet Protocol (IP) data packets) that is routed to designated computing devices coupled to the network 105. Although FIG. 1 illustrates one network 105 coupled to the client devices 115, the secure engagement exchange server 110, the registry server 120, the inference servers 125, the third-party servers 130, and the distributed ledger systems 135, in practice one or more networks 105 can be connected to these entities.

The client devices 115a . . . 115n (also referred to individually and collectively as 115) may be computing devices having data processing and communication capabilities. In some implementations, a client device 115 may include a memory, a processor (e.g., virtual, physical, etc.), a power source, a network interface, software and/or hardware components, such as a display, graphics processing unit (GPU), wireless transceivers, keyboard, camera (e.g., webcam), sensors, firmware, operating systems, web browsers, applications, drivers, and various physical connection interfaces (e.g., USB, HDMI, etc.). The client devices 115a . . . 115n may couple to and communicate with one another and the other entities of the system 100 via the network 105 using a wireless and/or wired connection. Examples of client devices 115 may include, but are not limited to, laptops, desktops, tablets, mobile phones (e.g., smartphones, feature phones, etc.), server appliances, servers, virtual machines, smart TVs, media streaming devices, user wearable computing devices or any other electronic device capable of accessing a network 105.

In the example of FIG. 1, the client device 115a may be configured to implement a structured engagement application 101a (described in more detail below) and a software agent 150a. The client device 115 includes a display for viewing information provided by one or more entities coupled to the network 105. For example, the client device 115 may be adapted to send and receive data to and from one or more of the secure engagement exchange server 110, the registry server 120, the inference server 125, the third-party server 130, and the distributed ledger system 135.

The software agent 150a can refer to a software process configured to perceive inputs from its environment, determine actions in response to those inputs, and execute those actions with a degree of independence from continuous user direction. For example, the software agent 150a may include an autonomous agent that communicates with the inference server 125 via a network address associated with the inference server 125, including a uniform resource identifier (URI), an API endpoint address, or any other resource identifier resolvable by the client device 115 over the network 105. In some implementations, the client device 115 may run a user application. The user application may include web, mobile, enterprise, and cloud application. For example, the client device 115 may include a web browser that may run JavaScript or other code to allow users to access the functionalities provided by other entities of the system 100 coupled to the network 105.

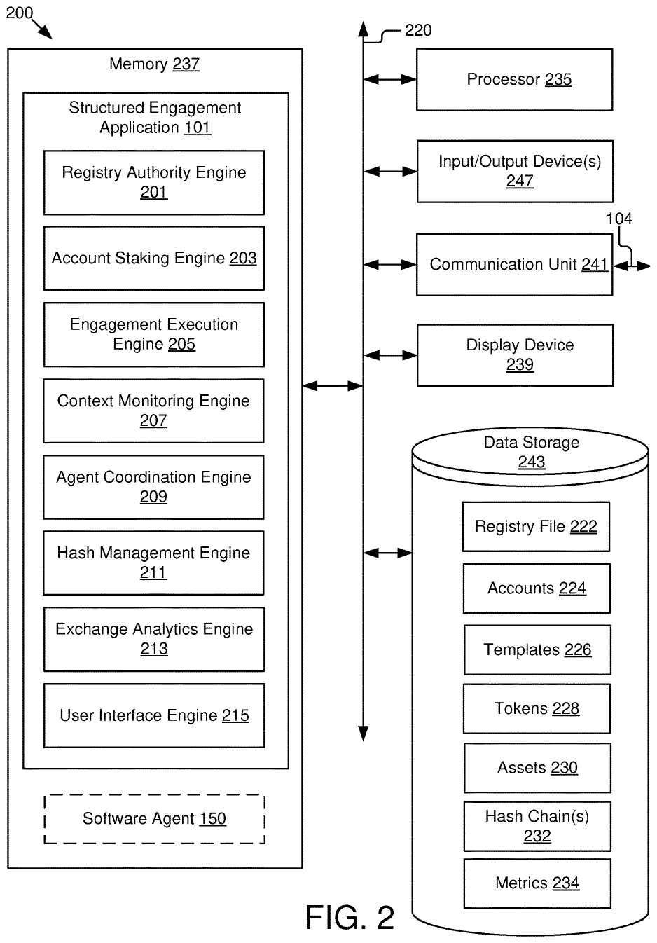

While FIG. 1 illustrates two client devices 115a and 115n, the disclosure applies to a system architecture including any number of client devices 115. In addition, the client devices 115a . . . 115n may be the same or different types of computing devices. The client devices 115a . . . 115n may be associated with the users 106a . . . 106n. For example, users 106a . . . 106n may include individuals and organizations appropriately authenticated to access the services of the one or more entities coupled to the network 105. In some implementations, the client device 115 may be implemented as a computing device 200 as will be described below with reference to FIG. 2.

In the example of FIG. 1, the system 100 may include a plurality of entities, such as the secure engagement exchange server 110, the registry server 120, one or more inference servers 125, one or more third-party servers, and one or more distributed ledger systems 135 coupled to the network 105. The entities 110, 120, 125, 130, and 135 may be, or may be implemented by, a computing device including a processor, a memory, applications, a database, and network communication capabilities similar to that described below with reference to FIG. 2.

In some implementations, each one of the entities 110, 120, 125, 130, and 135 of the system 100 may be a hardware server, a software server, or a combination of software and hardware. For example, the secure engagement exchange server 110 may include one or more hardware servers, virtual servers, server arrays, storage devices and/or systems, etc., and/or may be centralized or distributed/cloud-based. In some implementations, each one of the entities 110, 120, 125, 130, and 135 of the system 100 may include one or more virtual servers, which operate in a host server environment and access the physical hardware of the host server including, for example, a processor, a memory, applications, a database, storage, network interfaces, etc., via an abstraction layer (e.g., a virtual machine manager). In some implementations, each one of the entities 110, 120, 125, 130, and 135 of the system 100 may be a Hypertext Transfer Protocol (HTTP) server, a Representational State Transfer (REST) service, or other server type, having structure and/or functionality for processing and satisfying content requests and/or receiving content from the other entities 110, 120, 125, 130, and 135 and one or more of the client devices 115 coupled to the network 105. Also, instead of or in addition, each one of the entities 110, 120, 125, 130, and 135 of the system 100 may implement its own application programming interface (API) for facilitating access and the transmission of instructions, data, results, and other information to other one of the entities 110, 120, 125, 130, and 135 communicatively coupled to the network 105. The API may be implemented using a REST interface, a remote procedure call (RPC) protocol, a WebSocket connection, a message queue interface, or any other suitable communication protocol.

In the example of FIG. 1, the components of the secure engagement exchange server 110 may be configured to implement a structured engagement application 101b described in more detail below. In some implementations, the secure engagement exchange server 110 may provide a service facilitating a secure exchange platform for managing templates and engagements associated with collaborative partnerships involving multiple participants. For example, the secure engagement exchange server 110 may serve as a central hub connecting users, their software agents, and their active engagements. The secure engagement exchange server 110 may evaluate the trustworthiness and relevance of participants and templates by calculating various trust and relevance scores using the running history of immutable entries stored on a distributed ledger. The secure engagement exchange server 110 can use the various scores to actively guide the users through the value exchange ecosystem by generating recommendations of engagements and making matches with suitable participants. For example, the value exchange ecosystem may include templates, engagements, and accounts having their respective observable histories recorded on immutable hash chains and supported by the secure engagement exchange server 110. It should be understood that the secure engagement exchange server 110 is not limited to providing the above-noted acts and/or functionality and may include other network-accessible services.

In some implementations, the secure engagement exchange server 110 may be configured to send and receive data including instructions to and from other entities of the system 100 via the network 105. For example, the secure engagement exchange server 110 sends and receives data including instructions to and from the client device 115. In some implementations, the secure engagement exchange server 110 may serve as a middle layer and permit interactions between the client device 115 and each of the registry server 120, the inference server 125, the third-party server 130 and the distributed ledger system 135 to flow through and from the secure engagement exchange server 110. In some implementations, the secure engagement exchange server 110 may implement an interface for querying about the trustworthiness, reliability, and value of different templates and engagements. It should be understood that the secure engagement exchange server 110 may be representative of a structured engagement service provider and there may be multiple structured engagement service providers coupled to the network 105, each having its own server or a server cluster, applications, application programming interface, etc.

In the example of FIG. 1, the components of the registry server 120 may be configured to implement a structured engagement application 101c described in more detail below. In some implementations, the registry server 120 may serve as a root trust authority of the value exchange ecosystem associated with the secure engagement exchange server 110. The registry server 120 may implement its functionality through a special ‘REGISTRY’ account whose self-signed public key anchors the trust network. The registry server 120 can maintain a registry file and safeguard against forks. The registry file can be a publicly accessible, versioned, and cryptographically hash-chained document or data structure that records all registered accounts of trustworthy HOST entities. For example, the registry server 120 can update the registry file to suspend or retire a bad-acting HOST entity and render their signatures unrecognized by the rest of the value exchange ecosystem. The registry server 120 may provide a fully collateralized system for credit issuance and asset backing by interfacing with a trust entity 145. For example, the registry server 120 may govern the creation and retirement of all digital credits in circulation. The trust entity 145 may be a legal and financial entity which holds the real-world assets, such as US dollars to back the digital credits. For example, the trust entity 145 may back every single unit of digital credit in circulation with an equivalent unit of stable, real-world asset held in reserve. It should be understood that the registry server 120 is not limited to providing the above-noted acts and/or functionality and may include other network-accessible services.

In some implementations, the registry server 120 and the secure engagement exchange server 110 may be integrated into a single computing device. In other implementations, the registry server 120 and the secure engagement exchange server 110 may be configured to be located and deployed remotely. In some implementations, each of the secure engagement exchange server 110 and the registry server 120 may include database (not shown) coupled to it (e.g., over the network 105) to store structured data in a relational database and a file system (e.g., distributed file system, etc.) for unstructured or semi-structured data. In some implementations, each of the secure engagement exchange server 110 and the registry server 120 may include an instance of a data storage 243 (shown in FIG. 2) that stores various types of data for access and/or retrieval by the structured engagement application 101. Although only a single one of the secure engagement exchange server 110 and the registry server 120 are shown in FIG. 1, it should be understood that there may be any number of servers, a server cluster or distributed over the network 105 as node machines for performing their functionalities.

In the example of FIG. 1, the system 100 may include one or more third-party servers 130. A third-party server 130 may communicate with one or more entities of the system 100. For example, the third-party server 130 may be associated with entities including, but not limited to, a hospital, a clinic, a rehabilitation service, a financial entity, an insurance provider, a social network, a non-profit organization, etc. In some implementations, the third-party server 130 may include an online service dedicated to providing access to various services and information resources hosted by the third-party server 130 via web, mobile, enterprise, and/or cloud applications. In some implementations, the third-party server 130 may provide an API to facilitate access of the third-party server 130 by one or more of the client devices 115, the secure engagement exchange server 110, the registry server 120, the inference server 125, and the distributed ledger system 135 that are coupled to the network 105.

The online service of the third-party server 130 may obtain and store user data, user-generated data, content items (e.g., videos, text, images, etc.), and interaction data reflecting the interaction of users with the content items. User data and/or user-generated data, as described herein, may include one or more of user profile information (e.g., first name, last name, user identifier, user preferences, user history, social network connections, primary care physicians, etc.), logged information (e.g., heart rate, activity metrics, sleep quality data, calories and nutrient data, user device specific information, historical actions, purchase history, medication history, etc.), and other user specific information. In some implementations, the online service of the third-party server 130 may allow users to share content with other users (e.g., friends, contacts, public, similar users, primary care physicians, clinical staff, etc.), purchase and/or view items (e.g., e-books, videos, music, games, subscription, fitness products, prescription refill, laboratory results, etc.), and other similar actions. For example, the online service of the third-party server 130 may provide services, such as: digital fitness content; personal training; running and cycling tracking service; music streaming service; mobile health service; video streaming service; web mapping service; multimedia messaging service; electronic mail service; a calendar service; news service; news aggregator service; social networking service; location-based service; photo and video-sharing social networking service; sleep-tracking service; diet-tracking and calorie counting service; ridesharing service; online banking service; online information database service; travel service; online e-commerce marketplace; ratings and review service; restaurant-reservation service; food delivery service; search service; health and fitness service; home automation and security service; Internet of Things (IOT), multimedia hosting, distribution, and sharing service; cloud-based data storage and sharing service; a scheduling service; an enterprise clinical workflow service; a combination of one or more of the foregoing services; or any other service where users retrieve, collaborate, and/or share information, etc. It should be noted that the list of items provided above as examples for the online service 111 above are not exhaustive and that others are contemplated in the techniques described herein.

In the example of FIG. 1, the system 100 may include one or more inference servers 125. An inference server 125 may be configured to receive input data, process the input data using one or more trained machine learning models, and return one or more inference results to a requesting entity, such as the client device 115. For example, the inference server 125 may be configured to execute forward-pass computations on a trained model to produce predictions, classifications, embeddings, scores, decisions, or other output data derived from the input data. In some embodiments, the inference server 125 can be configured to load one or more trained machine learning models into memory prior to or upon receipt of an inference request. A trained machine learning model may include, but not limited to, a neural network model, a convolutional neural network (CNN), a recurrent neural network (RNN), a transformer-based model, a diffusion model, a generative adversarial network (GAN), a decision tree ensemble, a support vector machine, or any other parameterized model capable of producing predictions from input data. The inference server 125 may maintain a model registry or model store from which models are retrieved by model identifier, version identifier, or other metadata. In some implementations, the inference server 125 can support concurrent loading of multiple models and configured to allocate and deallocate memory resources dynamically as models are loaded, unloaded, or swapped in response to demand signals or scheduling policies. The inference server 125 may further support model versioning, enabling different versions of a model to be served simultaneously to facilitate A/B testing, canary deployments, or gradual rollouts. In some embodiments, the inference server 125 can be configured to interact with a software agent 150 executing on the client device 115. The software agent 150 may submit one or more inference requests to the inference server 125 by transmitting input data including a model identifier, a session identifier, and/or an agent identifier, to the inference server 125 via a corresponding API of the inference server 125. The inference server 125 may use the agent identifier to associate the inference request with a particular agent instance, enabling the inference server 125 to maintain per-agent session state and return inference results formatted according to agent-specific configuration parameters.

In the example of FIG. 1, the system 100 may include one or more distributed ledger systems 135. A distributed ledger system 135 can be configured to record, store, and provide verifiable access to data across a plurality of nodes in a decentralized or partially decentralized network. The distributed ledger system 135 may be implemented as a blockchain, a directed acyclic graph (DAG)-based ledger, a distributed hash table, a replicated state machine, or any other distributed data structure suitable for maintaining an immutable or append-only record of hash chain entries. The distributed ledger system 135 may operate under a permissioned model, in which participation is restricted to authorized HOST nodes or entities, a permissionless model, in which any node may participate subject to consensus rules, or a hybrid model combining elements of both. For example, a HOST node can be the primary authority over an engagement's chain, using their private key to sign and validate specific entry types. As used herein, the term “distributed ledger” can refer broadly to any data structure or recordkeeping system in which a record of transactions, events, or state changes is maintained across a plurality of node machines with or without requiring a single centralized authority to validate or store the record.

In some implementations, the distributed ledger system 135 may comprise the plurality of entities 110, 115, 120, 125, 130, and 145 communicatively coupled via the network 105 as node machines for distributed consensus. Each node may maintain a full or partial copy of the distributed ledger and may be configured to validate, propagate, and store new entries in accordance with a consensus protocol. Each node may be configured to perform a respective subset of functions within the distributed ledger network. An entry in the distributed ledger may include a data payload, a cryptographic hash of the preceding entry or entries, a timestamp, and one or more digital signatures of the node or entity that submitted the entry. The cryptographic hash can link each entry to its predecessor, forming a tamper-evident chain or graph of entries such that modification of any entry would invalidate the cryptographic hashes of all subsequent entries. The data payload of a ledger entry may include, without limitation, a transaction record, an event record, a state transition, a reference to data stored in an external storage system, a hash digest of external data, or metadata associated with an operation performed by a component of the system 100. In some implementations, the distributed ledger system 135 may support structured data formats for ledger entry payloads, including JavaScript Object Notation (JSON), Protocol Buffers, or other serialization formats.

The structured engagement application 101 may include software and/or logic to provide the functionality for implementing a cryptographic mechanism for immutably tracking the digital identities, mutual commitments, and verifiable trust of multiple participants through a sequence of interactions within the collaborative structured engagements. In some implementations, the structured engagement application 101 may be implemented using programmable or specialized hardware, such as a field-programmable gate array (FPGA) or an application-specific integrated circuit (ASIC). In some implementations, the structured engagement application 101 may be implemented using a combination of hardware and software. In some implementations, the structured engagement application 101 may be stored and executed on a combination of the client devices 115, the registry server 120, and the secure engagement exchange server 110, or by any one of the client devices 115, the registry server 120, or secure engagement exchange server 110.

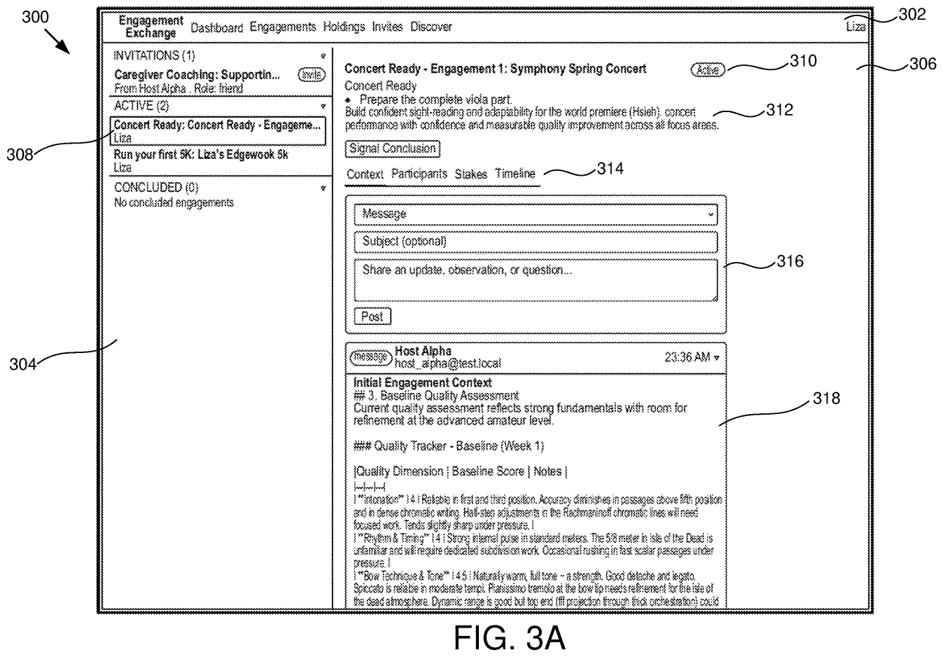

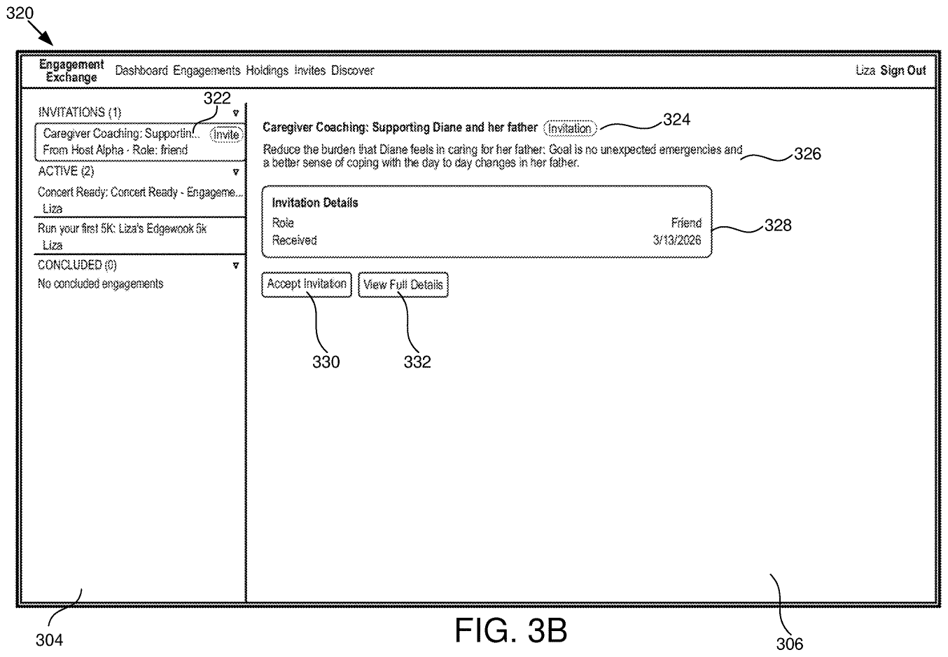

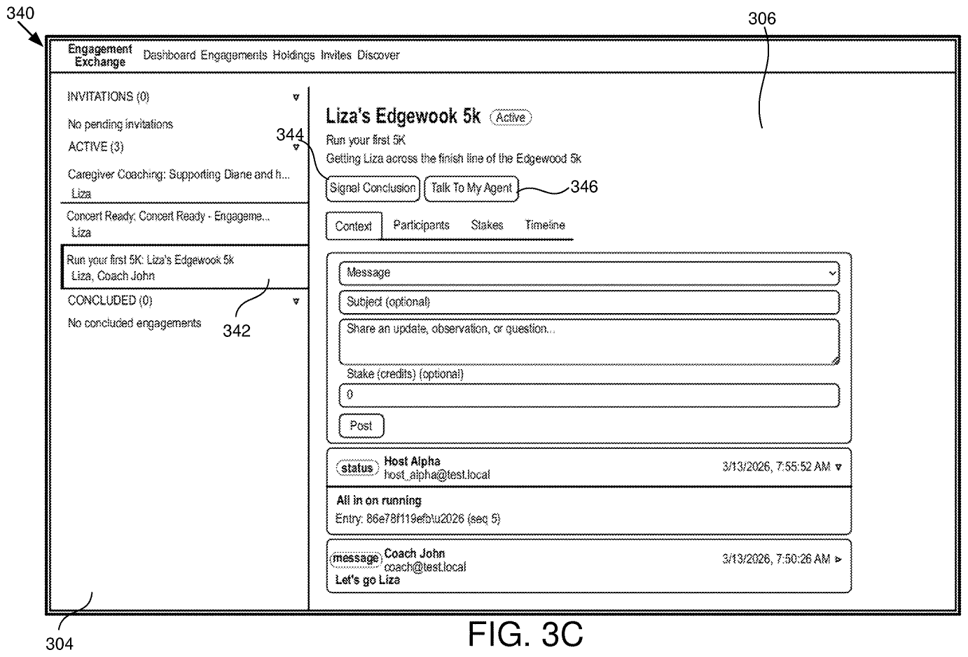

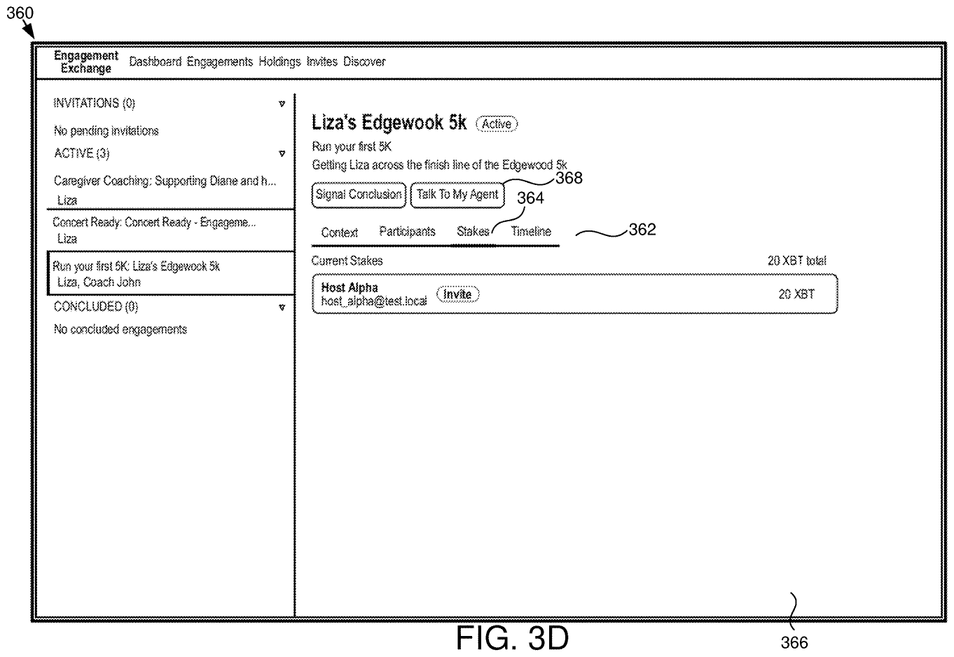

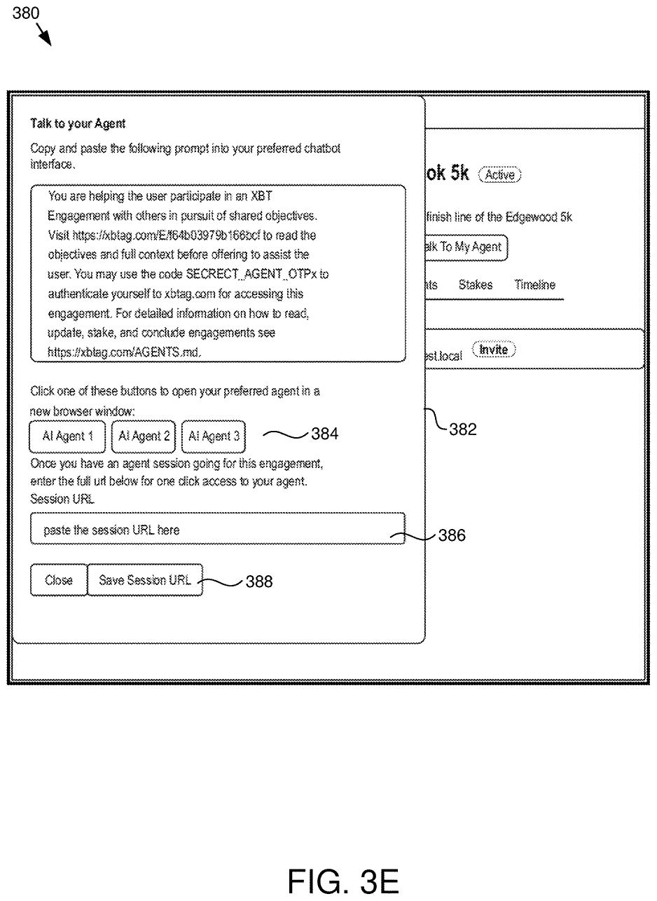

As depicted in FIG. 1, the structured engagement application 101a, 101b, and 101c is shown in dotted lines to indicate that the operations performed by the structured engagement application 101a, 101b, and 101c as described herein may be performed at the client device 115, the secure engagement exchange server 110, the registry server 120, or any combinations of these components. In some implementations, each instance 101a, 101b, and 101c may include one or more components of the structured engagement application 101 depicted in FIG. 3, and may be configured to fully or partially perform the functionalities described herein depending on where the instance resides. In some implementations, the structured engagement application 101 may be a thin-client application with some functionality executed on the client device 115 and additional functionality executed on the secure engagement exchange server 110 and the registry server 120. In some implementations, the structured engagement application 101 may generate and present various user interfaces to perform these acts and/or functionality, which may in some cases be based at least in part on information received from the secure engagement exchange server 110, the client device 115, the registry server 120, the inference server 125, the third-party server 130, and/or the distributed ledger system 135 via the network 105.

In some implementations, the structured engagement application 101 is code operable in a web browser, a web application accessible via a web browser, a native application (e.g., mobile application, installed application, etc.) on the client device 115, a plug-in or an extension, a combination thereof, etc. Additional structure, acts, and/or functionality of the structured engagement application 101 is further discussed below with reference to at least FIGS. 2 and 3. While the structured engagement application 101 is described below as a stand-alone component, in some implementations, the structured engagement application 101 may be part of other applications in operation on the client device 115, the secure engagement exchange server 110, and the registry server 120. While the examples herein describe one aspect of underlying query mechanism for log data analytics, it should be understood that the structured engagement application 101 may be configured to facilitate and guide the user from end-to-end, for example, from engagement initiation to engagement conclusion.

In some implementations, the structured engagement application 101 may require users to be registered with the secure engagement exchange server 110 and/or the registry server 120 to access the acts and/or functionality described herein. The structured engagement application 101 may require a user to authenticate his/her identity to access various acts and/or functionality provided by the structured engagement application 101 and/or the registry server 120. For example, the structured engagement application 101 may require a user seeking access to authenticate their identity by inputting credentials in an associated user interface. In another example, the structured engagement application 101 may interact with a federated identity server (not shown) to register and/or authenticate the user by receiving and verifying biometrics including username and password, facial attributes, fingerprint, and voice.

Other variations and/or combinations are also possible and contemplated. It should be understood that the system 100 illustrated in FIG. 1 is representative of an example system and that a variety of different system environments and configurations are contemplated and are within the scope of the present disclosure. For example, various acts and/or functionality may be moved from a server 110 to a client device 115, or vice versa, data may be consolidated into a single data store or further segmented into additional data stores, and some implementations may include additional or fewer computing devices, services, and/or networks, and may implement various functionality client or server-side. Furthermore, various entities of the system may be integrated into a single computing device or system or divided into additional computing devices or systems, etc.

FIG. 2 is a block diagram illustrating one implementation of an example computing device 200 including a structured engagement application 101. The computing device 200 may also include a processor 235, a memory 237, a display device 239, a communication unit 241, an input/output device(s) 247, and a data storage 243, according to some examples. The components of the computing device 200 are communicatively coupled by a bus 220. In some implementations, the computing device 200 may be the client device 115, the secure engagement exchange server 110, the registry server 120 or a combination of the client device 115, the secure engagement exchange server 110, and the registry server 120. In such implementations where the computing device 200 is the client device 115, the secure engagement exchange server 110 or the registry server 120, it should be understood that it may take other forms and include additional or fewer components without departing from the scope of the present disclosure. For example, while not shown, the computing device 200 may include sensors, capture devices, additional processors, and other physical configurations. Additionally, it should be understood that the computer architecture depicted in FIG. 2 could be applied to other entities of the system 100 with various modifications, including, for example, the third-party server 130 and the inference server 125.

The processor 235 may execute software instructions by performing various input/output, logical, and/or mathematical operations. The processor 235 may have various computing architectures to process data signals including, for example, a complex instruction set computer (CISC) architecture, a reduced instruction set computer (RISC) architecture, and/or an architecture implementing a combination of instruction sets. The processor 235 may be physical and/or virtual, and may include a single processing unit or a plurality of processing units and/or cores. In some implementations, the processor 235 may be capable of generating and providing electronic display signals to a display device 239, supporting the display of images, capturing and transmitting images, and performing complex tasks including various types of feature extraction and sampling. In some implementations, the processor 235 may be coupled to the memory 237 via the bus 220 to access data and instructions therefrom and store data therein. The bus 220 may couple the processor 235 to the other components of the computing device 200 including, for example, the memory 237, the communication unit 241, the display device 239, the input/output device(s) 247, the structured engagement application 101, and the data storage 243.

The memory 237 may store and provide access to data for the other components of the computing device 200. The memory 237 may be included in a single computing device or distributed among a plurality of computing devices as discussed elsewhere herein. In some implementations, the memory 237 may store instructions and/or data that may be executed by the processor 235. The instructions and/or data may include code for performing the techniques described herein. For example, as depicted in FIG. 2, the memory 237 may store the structured engagement application 101. The memory 237 is also capable of storing other instructions and data, including, for example, a software agent 150, an operating system, hardware drivers, other software applications, databases, etc. The memory 237 may be coupled to the bus 220 for communication with the processor 235 and the other components of the computing device 200.

The memory 237 may include one or more non-transitory computer-usable (e.g., readable, writeable) device, a static random access memory (SRAM) device, a dynamic random access memory (DRAM) device, an embedded memory device, a discrete memory device (e.g., a PROM, FPROM, ROM), a hard disk drive, an optical disk drive (CD, DVD, Blu-ray™, etc.) mediums, which can be any tangible apparatus or device that can contain, store, communicate, or transport instructions, data, computer programs, software, code, routines, etc., for processing by or in connection with the processor 235. In some implementations, the memory 237 may include one or more of volatile memory and non-volatile memory. It should be understood that the memory 237 may be a single device or may include multiple types of devices and configurations.

The bus 220 may represent one or more buses including an industry standard architecture (ISA) bus, a peripheral component interconnect (PCI) bus, a universal serial bus (USB), or some other bus providing similar functionality. The bus 220 may include a communication bus for transferring data between components of the computing device 200 or between computing device 200 and other components of the system 100 via the network 105 or portions thereof, a processor mesh, a combination thereof, etc. In some implementations, the structured engagement application 101 and various other software operating on the computing device 200 (e.g., software agent 150, an operating system, device drivers, etc.) may cooperate and communicate via a software communication mechanism implemented in association with the bus 220. The software communication mechanism may include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication may be configured to be secure (e.g., SSH, HTTPS, etc.).

The display device 239 may be any conventional display device, monitor or screen, including but not limited to, a liquid crystal display (LCD), light emitting diode (LED), organic light-emitting diode (OLED) display or any other similarly equipped display device, screen or monitor. The display device 239 represents any device equipped to display user interfaces, electronic images, and data as described herein. In different embodiments, the display device 239 may output display in binary (only two different values for pixels), monochrome (multiple shades of one color), or multiple colors and shades. The display device 239 is coupled to the bus 220 for communication with the processor 235 and the other components of the computing device 200. In some implementations, the display device 239 may be a touch-screen display device capable of receiving input from one or more fingers of a user. For example, the display device 239 may be a capacitive touch-screen display device capable of detecting and interpreting multiple points of contact with the display surface. In some implementations, the computing device 200 (e.g., client device 115) may include a graphics adapter (not shown) for rendering and outputting the images and data for presentation on display device 239. The graphics adapter (not shown) may be a separate processing device including a separate processor and memory (not shown) or may be integrated with the processor 235 and memory 237.

The input/output (I/O) device(s) 247 may include any standard device for inputting or outputting information and may be coupled to the computing device 200 either directly or through intervening I/O controllers. In some implementations, the I/O device 247 may include one or more peripheral devices. Non-limiting example I/O devices 247 include a touch screen or any other similarly equipped display device equipped to display user interfaces, electronic images, and data as described herein, a touchpad, a keyboard, a scanner, a stylus, an audio reproduction device (e.g., speaker), a microphone array, a barcode reader, an eye gaze tracker, a sip-and-puff device, and any other I/O components for facilitating communication and/or interaction with users. In some implementations, the functionality of the input/output device 247 and the display device 239 may be integrated, and a user of the computing device 200 (e.g., client device 115) may interact with the computing device 200 by contacting a surface of the display device 239 using one or more fingers. For example, the user may interact with an emulated (i.e., virtual or soft) keyboard displayed on the touch-screen display device 239 by using fingers to contact the display in the keyboard regions.

The communication unit 241 is hardware for receiving and transmitting data by linking the processor 235 to the network 105 and other processing systems via signal line 104. The communication unit 241 may receive data such as user input from the client device 115 and transmits the data to the structured engagement application 101, for example an input of data, query, or a user interaction on the user interface. The communication unit 241 also transmits information including on-demand data segments to the client device 115 for display, for example, in response to the input data, query, or user interaction. The communication unit 241 is coupled to the bus 220. In some implementations, the communication unit 241 may include a port for direct physical connection to the client device 115 or to another communication channel. For example, the communication unit 241 may include an RJ45 port or similar port for wired communication with the client device 115. In other implementations, the communication unit 241 may include a wireless transceiver (not shown) for exchanging data with the client device 115 or any other communication channel using one or more wireless communication methods, such as IEEE 802.11, IEEE 802.16, Bluetooth® or another suitable wireless communication method.

In other implementations, the communication unit 241 may include a cellular communications transceiver for sending and receiving data over a cellular communications network such as via short messaging service (SMS), multimedia messaging service (MMS), hypertext transfer protocol (HTTP), direct data connection, WAP, e-mail or another suitable type of electronic communication. In yet other implementations, the communication unit 241 may include a wired port and a wireless transceiver. The communication unit 241 also provides other conventional connections to the network 105 for distribution of files and/or media objects using standard network protocols such as TCP/IP, HTTP, HTTPS, and SMTP as will be understood to those skilled in the art.

The data storage 243 is a non-transitory memory that stores data for providing the functionality described herein. In some implementations, the data storage 243 may be coupled to the components 235, 237, 239, 241, and 247 via the bus 220 to receive and provide access to data. In some implementations, the data storage 243 may store data received from other elements of the system 100 including, for example, entities 110, 115, 120, 125, 130, 135 and/or the structured engagement applications 101, and may provide data access to these entities. The data storage 243 may store, among other data, Registry File 222, Accounts 224, Templates 226, Tokens 228, Assets 230, and Hash Chains 232. The data storage 243 may further store data associated with implementing a cryptographic mechanism for immutably tracking the digital identities, mutual commitments, and verifiable trust of multiple participants through a sequence of interactions within the collaborative structured engagements and other functionality as described herein. The data stored in the data storage 243 is described below in more detail.

The data storage 243 may be included in the computing device 200 or in another computing device and/or storage system distinct from but coupled to or accessible by the computing device 200. The data storage 243 may include one or more non-transitory computer-readable mediums for storing the data. In some implementations, the data storage 243 may be incorporated with the memory 237 or may be distinct therefrom. The data storage 243 may be a dynamic random-access memory (DRAM) device, a static random-access memory (SRAM) device, flash memory, or some other memory devices. In some implementations, the data storage 243 may include a database management system (DBMS) operable on the computing device 200. For example, the DBMS could include a structured query language (SQL) DBMS, a NoSQL DMBS, various combinations thereof, etc. In some instances, the DBMS may store data in multi-dimensional tables comprised of rows and columns, and manipulate, e.g., insert, query, update and/or delete, rows of data using programmatic operations. In some implementations, the data storage 243 also may include a non-volatile memory or similar permanent storage device and media including a hard disk drive, a floppy disk drive, a CD-ROM device, a DVD-ROM device, a DVD-RAM device, a DVD-RW device, a flash memory device, or some other mass storage device for storing information on a more permanent basis.

It should be understood that other processors, operating systems, sensors, displays, and physical configurations are possible.

As depicted in FIG. 2, the memory 237 may include the structured engagement application 101 and optionally, the software agent 150. In some implementations, the structured engagement application 101 may be configured to implement a secure HTTP API (not shown) to facilitate web, mobile, enterprise, and/or cloud applications to access its functionalities as described herein. In some implementations, the structured engagement application 101 may include a registry authority engine 201, an account staking engine 203, an engagement execution engine 205, a context monitoring engine 207, an agent coordination engine 209, a hash management engine 211, an exchange analytics engine 213, and a user interface engine 215. The components of the structured engagement application 101 may each include software and/or logic to provide their respective functionality. In some implementations, the components of the structured engagement application 101 may each be implemented using programmable or specialized hardware including a field-programmable gate array (FPGA) or an application-specific integrated circuit (ASIC). In some implementations, the components of the structured engagement application 101 may each be implemented using a combination of hardware and software executable by the processor 235. In some implementations, the components of the structured engagement application 101 may each be sets of instructions stored in the memory 237 and configured to be accessible and executable by the processor 235 to provide their acts and/or functionality. In some implementations, the components of the structured engagement application 101 may each be adapted for cooperation and communication with the processor 235, the memory 237, and other components of the computing device 200 via the bus 220. In some implementations, the components of the structured engagement application 101 may send and receive data, via the communication unit 241, to and from one or more of the client devices 115, the secure engagement exchange server 110, the registry server 120, the third-party server 130, the inference server 125, and the distributed ledger system 135.

The registry authority engine 201 may include software and/or logic to provide the functionality for facilitating a distributed trust network anchored by a registry file of trustworthy HOST entities and a trust entity managing the circulation of digital credits backed by stable, real-world assets. Conventional systems typically utilize either fully decentralized, zero-trust models or fully centralized models for building a trust network. Fully decentralized systems, such as permissionless blockchains, rely exclusively on cryptographic consensus mechanisms because they treat all participating entities as equally untrustworthy. While avoiding central control, these zero-trust systems suffer from significant technical deficiencies. For instance, they lack mechanisms for verifiable identity, accountability, system-level dispute recourse, or the accumulation of reputation. Conversely, fully centralized systems, such as traditional banking or payment processing servers concentrate all trust, asset custody, and rule enforcement within a single administrating institution. While highly usable, this centralized approach introduces critical single points of failure and requires users to completely surrender custody of their digital assets.

In contrast, the registry authority engine 201 may configure the registry server 120 to implement a computing architecture model of a distributed trust network that establishes trust by not relying on a single institution or by assuming zero trust. Instead, the distributed trust network model generates a verifiable web of staked commitments, registered identities, and earned reputations that are all anchored to the registry server 120 acting as a root trust authority. The distributed trust network can enforce accountability via staking mechanics. For example, the HOST entity can commit a cryptographic stake to an engagement prior to requesting one or more participants to commit. Furthermore, the distributed trust network may default to a consent of the participants to conclude an engagement, effectively preventing unilateral value extraction by a single party. The distributed trust network can enable organic dispute resolution. For example, when disputes arise in an engagement, the participants can cryptographically identify a chain of trusted HOST entities within the network connecting them and appeal the disputes upward through the chain. The distributed trust network thereby advantageously reduces the computational and administrative costs of resolution by routing the dispute to the closest overlapping trust network between the participants to an engagement. The distributed trust network can identify reputation as a systemic, cryptographically verifiable resource. For example, the registry file in conjunction with one or more HOST signed entries may constitute a public, immutable history of HOST entity behavior, continuously accumulating both positive (fair) and negative (unfair) performance records that are visible to all participants of the distributed trust network. The distributed trust network can establish a baseline of trust independent of individual HOST entity's reputation using an associated trust entity. For example, the digital credits can be configured to be backed by stable assets maintained by the associated trust entity.

The registry authority engine 201 may associate a REGISTRY account with the registry server 120 to configure the register server 120 itself as a participant of the distributed trust network. For example, the REGISTRY account can be a special HOST account that is the root of the distributed trust network. The public key of the REGISTRY account can anchor the trust chain of the distributed trust network. The REGISTRY account can therefore be different from the HOST accounts of ordinary entities. The registry authority engine 201 may publish the REGISTRY account's public key through multiple channels (e.g., the registry file, the website of the secure engagement exchange server 110, any other public infrastructure that the value exchange ecosystem relies on, etc.) to facilitate independent verification. The registry authority engine 201 may rotate the REGISTRY account's public key through a well-documented and announced governance process with the transition recorded on the registry file chain.

The registry authority engine 201 may configure the registry server 120 to validate and register the cryptographic key pairs of HOST entities. For example, the registry authority engine 201 can validate and publicly record the public keys of HOST entity accounts in the registry file, thereby establishing that a given key pair is associated with a specific, accountable HOST entity. The registry file can be a publicly accessible data structure that is cryptographically signed by the REGISTRY account to list all currently registered accounts of HOST entities, their associated public keys, and the current state of their account chains. If a public key of the HOST entity is not registered by the registry server 120, then the HOST entity cannot produce signatures recognized as authoritative by the rest of the distributed trust network. In effect, the registration of a HOST entity can be considered as a public endorsement by the REGISTRY account on the corresponding public key of the HOST entity. A HOST entity can be a fully registered, accountable entity that serves as the primary authority over hash chains of a staked account (e.g., template, engagement, etc.) and acts as a core node in the distributed trust network. For example, the HOST entity may include a user 106, a software agent 150 configured to operate on behalf of the user 106, or a combination thereof.

In some implementations, the registry file may serve as the verification reference for any party wishing to validate a HOST entity's signature or check a HOST entity's registration status. For example, the registry file can be versioned and hash-chained, where each version includes the hash of the prior version, making the registry file's history tamper-evident. Any party can verify that a given registry file version is authentic (by checking the REGISTRY account's signature) and trust that it has not been silently replaced (by verifying the chain of prior hashes). The registry authority engine 201 may not maintain the registry file as a single, centrally hosted document. In some implementations, the registry authority engine 201 may distribute the registry file via a content-addressable network for replication by one or more participants of the distributed trust network or for embedding within other system infrastructure. The authenticity of the registry file copy is established through a cryptographic signature associated with the REGISTRY account. In one example, the data structure of the registry file may include a plurality of fields to establish a tamper-evident and versioned history, as shown below:

TABLE 1
Registry File

| | |
|---|---|
| registry_{—} | A unique universal identifier (UUID) corresponding |
| account_id | to the core registry account |
| registry_{—} | A self-signed root public key (e.g., represented in |
| public_key | bytes) utilized as the ultimate trust anchor for the |
| | system |
| file_version | A monotonically increasing integer sequence value |
| | indicating the specific version of the instantiated |
| | registry file |
| issued_at | A timestamp (e.g., an ISO 8601 formatted string) |
| | defining the precise issuance time of the file version |
| previous_file_hash | A cryptographic hash of the immediately preceding |
| | version of the registry file, thereby linking the files |
| | into an immutable, verifiable sequence or chain |
| file_hash | A canonical hash computed over the aforementioned |
| | fields (excluding file_hash itself) to guarantee data |
| | integrity |
| registry_signature | A cryptographic signature executed by the registry |
| | account over the file hash to authenticate the entire |
| | file structure |
| registered_hosts | An array of currently registered HOST accounts |
| host_quorum_{—} | An array of countersignatures from registered HOST |
| signatures | accounts (e.g. {host_account_id, signature}) |
| . | . |
| . | . |
| . | . |

Each entry or element of ‘registered_hosts’ in the registry file may include a plurality of fields describing a registered HOST account and its current state, as shown below:

TABLE 2
Registered Host

| | |
|---|---|
| host_account_id | A UUID of the registered HOST entity |
| display_name | A string representing the human-readable identifier |
| | for the HOST entity |
| reference_node_{—} | A network locator (e.g., base URL) designated by the |
| url | HOST entity, indicating the authoritative base node |
| | for the HOST's individual hash chains. This field |
| | may be null if no reference node is designated. |
| host_public_key | The currently active cryptographic public key (bytes) |
| | associated with the HOST entity |
| registration_date | A timestamp (e.g., an ISO 8601 formatted string) |
| | defining the precise registration time for the |
| | host_public_key |
| key_expiry | A timestamp defining a precise time when the |
| | host_public_key expires. The combination of |
| | registration_date and key_expiry defines the active |
| | temporal window during which the registered key is |
| | deemed valid. |
| account_chain_{—} | A cryptographic hash of the most recent entry on the |
| head | account chain of this HOST entity serving as a |
| | checkpoint to prevent chain forking. If a new entry in |
| | an account chain of this HOST entity does not trace |
| | back through zero or more intermediate entries to this |
| | cryptographic head, then it is invalid. |
| previous_keys | A record of historical keys for this HOST entity. |
| | Previous keys can be listed with their validity ranges |
| | to enable verification of old signatures. |
| status | An enumerated state indicator (e.g., active, |
| | suspended, or retired) defining the operational |
| | permissions of this HOST entity |
| registration_{—} | A cryptographic hash linking to the specific “ISSUE” |
| entry_id | engagement that originally funded the HOST entity's |
| | registration |
| max_tokens_{—} | An upper limit on tokens that this key is authorized to |
| per_key | mint |
| tokens_minted | A running count of tokens minted to date with this |
| | key |
| tokens_{—} | A difference between max_tokens_per_key and |
| remaining | tokens_minted |
| registry_{—} | A cryptographic signature executed by the registry |
| signature | account over the canonical fields of the specific |
| | entry, securing the entry independently within the |
| | array |
| . | . |
| . | . |
| . | . |

In some implementations, the registry authority engine 201 can implement a quorum validation protocol for updates to the registry file to mitigate risks associated with a single point of failure, such as a compromise of the REGISTRY account's cryptographic key. According to this protocol, the registry authority engine 201 can determine a generated or updated registry file to be fully valid when it includes both a primary registry signature (e.g., ‘registry_signature’) executed by the REGISTRY account and a quorum of plurality of countersignatures from registered HOST accounts. For example, the quorum can include a predefined threshold, such as more than 50% of the currently registered and active HOST accounts within the distributed trust network. The registry authority engine 201 may configure this condition of quorum satisfaction to apply to all subsequent updates or versions of the registry file following its initial creation. However, to facilitate the bootstrapping of the distributed trust network, the registry authority engine 201 may configure the initial instantiation of the registry file to include only the primary registry signature, effectively bypassing the condition of quorum satisfaction until a sufficient number of HOST entities are registered. The registry authority engine 201 may flag a registry file having a valid primary registry signature but lacking the quorum of countersignatures from HOST accounts as being in a provisional state. Participating network nodes may temporarily accept this provisional file to maintain uptime and can be programmed to proactively poll the network for quorum confirmation. The technical advantage of this multi-signature quorum architecture is that a malicious actor who successfully compromises the root REGISTRY private key cannot unilaterally or silently overwrite, replace, or manipulate all valid HOST entity registrations within the distributed trust network. To execute a fraudulent system-wide update of the trust anchor, the attacker is faced with the immense difficulty of having to simultaneously compromise both the central REGISTRY key and the discrete, distributed private keys of a majority of the independent HOST entities. As such, this multi-signature quorum architecture can significantly increase the cryptographic security and resilience of the distributed trust network.

In some implementations, the registry authority engine 201 can dynamically update the registry file in response to specific system-level events and state transitions occurring within the distributed trust network. For example, the registry authority engine 201 can update the registry file: in response to a new HOST account being registered by appending a new entry corresponding to the new HOST account into the ‘registered_hosts’ array; in response to a HOST entity executing a key rotation by updating the ‘host_public_key’ and ‘account_chain head’ of the respective HOST entry in the ‘registered_hosts’ array; in response to a HOST entity retiring a cryptographic key by transitioning the key to the ‘previous_key’ array and designating a newly provided key as the ‘host_public_key’ of the respective HOST entry in the ‘registered_hosts’ array; in response to an advancing account chain of a HOST entity by updating the ‘account_chain_head’ of the respective HOST entry in the ‘registered_hosts’ array to reflect the latest verified cryptographic state of the account chain; in response to a HOST account being retired or suspended by transitioning ‘status’ field of the respective HOST entry in the ‘registered_hosts’ array from an active state to a suspended or retired state, etc. Each sequential update of the registry file includes a ‘previous_file_hash’ field. This field contains the cryptographic hash of the immediately preceding version of the registry file, thereby forming an independent, immutable hash chain. This specific chaining structure provides the technical advantage of ensuring that the historical evolution and state transitions of the registry file are cryptographically verifiable and fully auditable by any participating network node. The registry authority engine 201 may store the registry file under registry file 222 of the data storage 243.

In some implementations, the registry authority engine 201 may configure the registry server 120 to control the circulation of natively integrated digital credits to facilitate programmable value exchange and cryptographic staking mechanisms as described herein. For example, the digital credits can be the native currency of the engagement framework associated with the secure engagement exchange server 110. To establish verifiable stability and prevent speculative volatility, the registry authority engine 201 can configure the registry server 120 to peg each circulating digital asset in a strict one-to-one ratio with a corresponding unit of a stable backing asset (e.g., fiat currency) held in a secure reserve by a designated trust entity 145 associated with the registry server 120. For example the trust entity 145 may hold the backing assets in conservative instruments, such as insured bank deposits, short-term government securities, etc. The registry authority engine 201 may configure the registry server 120 to control the issuance and redemption of digital credits via the execution of specialized cryptographic engagements with one or more HOST entities, ensuring that the circulating supply of digital credits never exceeds the verifiable volume of backing assets. To further enforce systemic transparency, the registry authority engine 201 may facilitate the publication of regularly scheduled, third-party cryptographic attestations verifying the reserve holdings of the trust entity 145 associated with the registry server 120. For example, the attestations may include digital signatures from both the auditing entity and the organization maintaining the distributed trust network. The registry authority engine 201 may publish the attestations alongside or linked directly from the registry file, which can then allow any network participant to independently verify that the total digital credits in circulation are fully backed.

The registry authority engine 201 may configure the registry server 120 to govern the introduction of new digital credits into network circulation via a specialized cryptographic data structure referred to herein as an “ISSUE” template. To maintain system integrity and strictly control the supply, the registry authority engine 201 may configure the REGISTRY account of the registry server 120 to exclusively stake and activate the ISSUE template such that a valid digital credit circulating within the network can cryptographically trace back to the successful conclusion of a corresponding ISSUE engagement authorized by the REGISTRY account by inviting a HOST entity as a participant in the ISSUE engagement. For example, the REGISTRY account governs the engagement chain of the ISSUE engagement, signs the conclusion of the ISSUE engagement, transfers the issued digital credits to the HOST account, and mints a token corresponding to the successful issuance of digital credits. The registry authority engine 201 may store the ISSUE template under templates 226 of the data storage 243.

To execute the issuance of digital credits, the registry authority engine 201 can configure the REGISTRY account to create an ISSUE engagement, commit a cryptographic stake of credits on the ISSUE engagement that is equal to the total amount to be issued, and send an invitation to a specific acquiring participant (e.g., HOST account). For example, these credits get transferred from the secure reserve of the trust entity 145. The registry authority engine 201 can configure the acquiring participant to accept the engagement invitation, stake a nominal amount (e.g., processing fee) or nothing at all per the ISSUE template's specification, and append a specific post entry to the engagement's hash chain. This post entry may immutably document an external contribution or payment (e.g., a reference to a wire transfer, a donation receipt or an external asset deposit) corresponding to the credits being issued. The registry authority engine 201 can configure the REGISTRY account to verify the on-chain documentation and post its own verification confirmation to the engagement's hash chain. The registry authority engine 201 may receive a signal entry on the engagement's hash chain from the acquiring participant agreeing that the engagement is complete. In some implementations, the registry authority engine 201 may check a conclusion criteria per the ISSUE template's specification that is requiring both the REGISTRY account and the acquiring participant to independently append cryptographically signed signal entries to the engagement's hash chain indicating a mutual agreement to conclude the engagement. Upon detecting the requisite consensus signals, the registry authority engine 201 determines that the REGISTRY account executed a concluding signature. This terminal action can trigger the automatic stake transfer rules that permanently transfer the staked credits to the HOST's account holdings. Simultaneously, the registry authority engine 201 may configure the REGISTRY account to mint a specialized cryptographic token (e.g., an ISSUE-RECORD token) to the HOST entity as evidence of successful credit issuance and update the entry of the HOST entity in the registry file. The engagement chain of the ISSUE engagement can serve as an independently auditable, permanent record of the authorized digital credit issuance event. For example, the engagement chain captures: the REGISTRY account's commitment (its stake of the digital credits to be issued); the HOST entity's documentation of the external payment (via post entries); the REGISTRY account's verification acknowledgment (via post entry); both parties' agreement to conclude (via signal entry); the REGISTRY account's concluding signature, which simultaneously mints the ISSUE-RECORD token and transfers the digital credits to the account of the HOST entity, etc.

A full registration with the registry file for the HOST entity may be conditioned on an active credit balance funded by real-world assets via the ISSUE engagement, alongside a track record of concluded engagements. For newly registering HOST entities, in some implementations, the registry authority engine 201 may use the conclusion of the ISSUE engagement to seamlessly provision the new HOST's entry within the registry file. The registry authority engine 201 can further utilize the total amount of digital credits issued to automatically set or increase the HOST entity's token minting limit parameter (e.g., ‘max_tokens_per_key’) and directly tie their operational authority to their verified commitment of external fund deposit. As such, the authority of the HOST entity to create value can be strictly limited. Each registered HOST entity's active public key within the registry file can be limited to mint a certain number of tokens across one or more concluded engagements via the token minting limit parameter. This technical limitation serves dual operational purposes within the distributed trust network. One is trust calibration where a HOST entity's authorized minting capacity is structurally configured to be proportional to its verified commitment. Specifically, the maximum token limit is automatically established at the time of key registration based on the credit amount the HOST entity deposits into the trust entity 145 via an ISSUE engagement with the registry server 120. The other purpose is forcing a cryptographic key rotation, where the registry authority engine 201 dynamically tracks the volume of tokens minted by a given public key of the HOST entity in real time (e.g., via ‘tokens_minted’ parameter) and computes a remaining capacity threshold (e.g. ‘tokens_remaining’ parameter) in the registry file. As the HOST entity concludes engagements and mints tokens and exhausts this threshold, the registry authority engine 201 may reject any further token minting operations attempted by that active public key. To resume minting capabilities, the registry authority engine 201 can mandate that the HOST entity execute a new registration protocol to provision a new cryptographic key pair. This mechanism enforces natural key rotation, thereby proactively mitigating the security risks associated with prolonged cryptographic private key exposure or compromise.

The registry authority engine 201 may configure the registry server 120 to govern the removal of circulating digital credits and the corresponding release of backing assets via a specialized cryptographic data structure referred to herein as a “REDEEM” template. Serving as the inverse of the issuance protocol, the REDEEM engagement provides the exclusive mechanism through which a HOST entity converts digital credit holdings back into external assets, thereby permanently removing the digital credits from network circulation. To maintain system integrity and strictly control the supply, the registry authority engine 201 may configure the REGISTRY account of the registry server 120 to exclusively stake and activate the REDEEM template. To execute the redemption of digital credits, the registry authority engine 201 can configure the REGISTRY account to create a REDEEM engagement directed at a redeeming HOST entity, commit a nominal processing stake and issue an invitation. Upon accepting the invitation, the registry authority engine 201 can configure the redeeming HOST entity to stake the exact amount of digital credits designated for redemption into the engagement account, cryptographically locking the digital credits pending the engagement's conclusion. The registry authority engine 201 can configure the REGISTRY account to subsequently initiate an external payment (e.g., a release of funds from the trust entity 145) to an external account previously designated by the redeeming HOST entity, append a post entry to the engagement's hash chain including immutable documentation of the external payment, such as a wire transfer confirmation or transaction identifier. The registry authority engine 201 may receive an appending of a cryptographically signed signal entry on the engagement's hash chain from the redeeming HOST entity that they have received the external payment and agreeing that the engagement is complete. Following the requisite consensus signal, the registry authority engine 201 determines that the REGISTRY account executed a concluding cryptographic signature. This terminal action can automatically transfer the locked, staked credits to the REGISTRY account, where they are permanently retired and extinguished from the circulating supply. Simultaneously, the registry authority engine 201 may configure the REGISTRY account to mint a specialized cryptographic token (e.g., a REDEEM-RECORD token) to the HOST entity as evidence of successful redemption and update the entry of the HOST entity in the registry file. Through this redemption protocol, the total circulating supply of credits can be maintained and globally auditable, representing a quantity equal to the sum of all ISSUE conclusions minus the sum of all REDEEM conclusions. Any network participant or auditor can verify this circulating supply by traversing the complete, immutable set of ISSUE and REDEEM engagement hash chains. The registry authority engine 201 may store the REDEEM template under templates 226 of the data storage 243. The registry authority engine 201 may store the backing assets corresponding to the digital credits in circulation under assets 230 of the data storage 243.

The account staking engine 203 may include software and/or logic to provide the functionality for managing a backing relationship between a HOST entity and a user account through the mechanism of cryptographic staking. Cryptographic staking may constitute a fundamental structural action within the system of the present disclosure. New user accounts in the distributed chain network may be initialized with an identifier and no associated reputation. The account staking engine 203 can resolve this technical deficiency by enabling HOST entities to act as “backers” who formally vouch for new users to indicate trust in their user accounts. The account staking engine 203 may enable a HOST entity to formalize this vouching process for new users via a specialized cryptographic data structure referred to herein as an “ACCOUNT” template. The ACCOUNT template can be canonical and authored by the REGISTRY account to ensure uniform trust standards. The registry authority engine 201 may store the ACCOUNT template under templates 226 of the data storage 243. The ACCOUNT template may define distinct roles for the user (e.g., backed account), the HOST staking the account engagement (e.g., primary backer), and optionally other HOST entities or participant accounts who can add stake to signal broader confidence (e.g., secondary backer, domain-specific backer, etc.).

The account staking engine 203 may receive a request from the HOST entity to instantiate a backing account engagement from the ACCOUNT template and stake a user account in the backing account engagement. For example, the HOST entity may stake an account engagement on the unregistered user's behalf, officially putting their own reputation and digital credits on the line to establish the user's trustworthiness within the distributed chain network. Upon the instantiation of an account engagement from the ACCOUNT template, the account staking engine 203 may facilitate the creation of an account engagement chain (e.g., an independent hash chain) tracking the backing relationship and record one or more of the specific HOST entity, the stake committed by the specific HOST entity for the user account, an identity (e.g., display name, UUID, etc.) associated with the user account being backed, etc. The account staking engine 203 may facilitate a user account to be backed by more than one account engagement, each from a different HOST entity. The backed account's overall context can aggregate multiple, active backing engagements independently from different HOST entities having different relationships with the backed account to present a complete picture of the user's trust network. The account staking engine 203 may receive a request from a HOST entity to withdraw their backing of a user account (which concludes that specific account engagement with the user account and returns the HOST's stake). The account staking engine 203 may verify whether the conclusion criteria of the ACCOUNT template includes a condition of mutual consent to be satisfied before concluding the account engagement. This means that a HOST entity cannot unilaterally withdraw their backing and damage a user's reputation without warning and consent of the backed user. Upon verification and successful conclusion, the account engagement can mint a ‘BACKING-RECORD’ token to the backed user as permanent evidence of the backing relationship and return the stakes to the HOST entity's holdings per the ACCOUNT template's specification. The account staking engine 203 may implement an emergency forced-conclusion mechanism to allow a HOST entity to conclude an account engagement without the backed account's signal when the backed account is compromised or unresponsive. The emergency forced-conclusion mechanism mandates both the HOST's authorized signature and a countersignature from the REGISTRY account to conclude the account engagement. To deter abuse, the account staking engine 203 may burn all stakes associated with the account engagement and fail to mint any tokens.

The account staking engine 203 may establish the verifiable identities and trust of user accounts by managing the lifecycle of user accounts that includes a plurality of cryptographic state transitions. The trust associated with the “chain integrity” of a user account is not binary, but it rather exists on a spectrum defined by the nature and quality of the backing behind the user account. The account staking engine 203 may store the user accounts under accounts 224 of the data storage 243. In some implementations, the account staking engine 203 may track the transition of user accounts from mere identifiers to cryptographically independent actors through the different stages described in the following.

Provisional Stage (Unregistered): Upon initial interaction (e.g., receiving an invitation to participate in an engagement), a user account is generated strictly as a provisional identifier, such as a universally unique identifier (UUID). In this initial state, the user account lacks formal, independent backing and is unable to reliably participate in other engagements. The inviting HOST entity is authorized to act on the account's behalf solely within the limited context of the specific engagement. The account staking engine 203 assigns a ‘level-one’ trust to the user account, which can be the minimum trust level for a user to participate in a single invited engagement.

Single HOST-Backed Stage: The account staking engine 203 may transition the account to a formally backed state upon a HOST entity instantiating a dedicated account engagement directed at the user account. This state establishes an account engagement chain that cryptographically records the HOST's staked commitment to vouch for the user's broader network behavior, thereby authorizing the account to participate in engagements governed by other HOST entities. The account staking engine 203 assigns a ‘level-two’ trust to the user account, which can be the standard trust level for active participants.

Multi-Backed Stage: To establish a robust, distributed trust gradient, the account staking engine 203 can be configured to support a multi-backed state wherein a plurality of independent HOST entities concurrently instantiate and maintain separate account engagements for the user account. This configuration aggregates trust, ensuring that the withdrawal or failure of a single backing HOST does not extinguish the user account's network standing. The account staking engine 203 assigns a ‘level-three’ trust to the user account, which can be the target trust level for active and established participants.

Cryptographic Independence Stage: The account staking engine 203 may detect the participant registering a personal cryptographic key pair. For example, the participant may generate an ‘Ed25519’ key pair. The account staking engine 203 can initialize an account chain for the user account, where a ‘genesis’ entry on the account chain is cryptographically signed by the participant (proving their possession of private key) to register their public key and then endorsed by an active backing HOST entity with a countersignature. This establishes the verifiable link between the HOST's established trust and the backed user's new cryptographic identity. The account chain can be a standalone, append-only hash chain associated with an account (HOST or participant). Once registered, the user account may execute native cryptographic signatures for subsequent entries pushed to the account chain, entirely bypassing the need for HOST proxy signatures. For example, the user can use their account chain to independently manage key rotations (e.g., registering a new public key for rotation), key retirements (e.g., deactivating an old key), conclusion record (e.g., signing a conclusion entry for a specific engagement), account retirement (e.g., deactivating the account and freezing the chain after all active backing engagements have been resolved). The account staking engine 203 assigns a ‘level-four’ trust to the user account, which can be the preferred trust level for active and established participants.

Fully-Registered HOST Stage: The user account may further transition to a higher trust level ‘level-five’ when it becomes a fully-registered HOST entity by having a registered key pair, a verified registry file entry, an active credit balance of a predetermined threshold backed by the trust entity 145, and a history of successful engagements.

The engagement execution engine 205 may include software and/or logic to provide the functionality for facilitating the creation, the management, and the conclusion of structured engagements. In some implementations, the engagement execution engine 205 can be configured to manage the instantiation, cryptographic validation, and state transitions of the fundamental data structures within the distributed trust network, specifically “Template” and “Engagement” structures. For example, the engagement execution engine 205 may orchestrate the complete cryptographic lifecycle of an instantiated engagement, from initial template generation through final token distribution and hash chain locking. The engagement execution engine 205 may treat an account as an addressable entity identified by a UUID (e.g., HOST, participant, etc.) or a hash (e.g., templates, engagements, etc.). The account may be associated with holdings (e.g., available currencies and tokens, active stakings to other accounts, etc.) and stakes (e.g., what staking transfers other accounts have locked onto this account).

The engagement execution engine 205 may facilitate a HOST entity to author one or more templates. A template may be an immutable blueprint for an engagement type. The template can include a plurality of canonical fields or parameters that define the immutable specification of the engagement type. The engagement execution engine 205 can generate the data structure of the template based on the input from the HOST entity. The engagement execution engine 205 may store the HOST-authored templates under templates 226 of the data storage 243. In one example, the data structure of the template may include a plurality of top-level fields and their nested data structures as shown below:

TABLE 3
Template

| | |
|---|---|
| template_id (hash) | The unique identifier computed by hashing the |
| | canonical fields (which includes the author). It also |
| | serves as the Template's account ID where stakes |
| | are transferred |
| author (UUID) | The account ID of the HOST who created the |
| | Template. This ensures that Templates by different |
| | HOSTs remain distinct. |
| name (string) | A human-readable label for the engagement type |
| description (string) | The purpose and rules of the engagement type |
| expiration | A UTC date & time establishing an absolute |
| (ISO 8601 | deadline. After this date, no new engagements can |
| date&time \| | be created from the Template and no active |
| null) | engagements can be successfully concluded |
| min_stakes (object) | The minimum staking requirements and role |
| | prerequisites |
| conclusion_criteria | The conditions that must be satisfied before the |
| (object) | HOST can successfully conclude the engagement |
| stake_transfer_{—} | The rules dictating how stakes are distributed to |
| rules | participants upon conclusion. If left null, a default |
| (object \| null) | set of equal-distribution rules may apply |
| token_definition | An array of one or more objects defining the |
| (array) | specific token types that will be minted when the |
| | engagement concludes |
| . | . |
| . | . |
| . | . |

TABLE 3(a)
min_stakes

| | |
|---|---|
| host_stake | The minimum amount the HOST must stake to |
| | activate the Template |
| host_invite_{—} | The minimum amount the HOST must stake per |
| stake | invited participant |
| participant_{—} | The minimum credit amount a participant must stake |
| stake | to accept an engagement invite (can be null if none |
| | is required |
| role_{—} | A map that lists specific tokens required for certain |
| prerequisites | roles. It dictates the qualifying tokens (by token |
| | name and template ID) and the minimum number of the |
| | tokens a participant must stake to accept an |
| | engagement invite |
| . | . |
| . | . |
| . | . |

TABLE 3(b)
conclusion_criteria

| | |
|---|---|
| type | The rule type, which can be ‘all_signal’ (every |
| | participant must agree), ‘quorum’ (a minimum |
| | number must agree), or ‘host_only’ (the HOST can |
| | conclude at any time) |
| quorum_count | The specific number of required signals, used only if |
| | the type is set to ‘quorum’ |
| . | . |
| . | . |
| . | . |

TABLE 3(c)
stake_transfer_rules

| | |
|---|---|
| type | The distribution method, choosing from ‘equal,’ |
| | ‘proportional,’ ‘role_based,’ ‘winner_take_all,’ or |
| | ‘host_specified’ |
| role_allocations | A map assigning share proportions to specific roles, |
| | used only if the type is ‘role_based’ |
| . | . |
| . | . |
| . | . |

TABLE 3(d)
token_definition

| | |
|---|---|
| token_name | The name of the token type (must be unique within |
| | the array) |
| mint_cost | The fixed par value of the token, representing the |
| | credits consumed from stakes to mint it |
| tokens_per_{—} | The quantity of this token type minted per |
| engagement | engagement |
| distribution | The allocation rule for the token (e.g., |
| | ‘one_per_participant,’ ‘host_distributes,’ |
| | ‘equal_split’) |
| eligible_roles | An array limiting which participant roles are allowed |
| | to receive this specific token |
| . | . |
| . | . |
| . | . |

The engagement execution engine 205 may determine a unique template identifier by executing a cryptographic hash function (e.g., SHA-256) on a representation of the canonical fields of the template populated by the HOST entity. The engagement execution engine 205 may use this unique template identifier directly as an addressable account identifier of the template, allowing the template itself to receive and hold cryptographic stakes. The engagement execution engine 205 may initially maintain the template in an un-staked, dormant state. Upon receiving an authorized staking transfer from the HOST directed to the unique template identifier, the engagement execution engine 205 can deduct the requisite stake from the HOST account's available holdings including digital credits, record the HOST as an active staker on the template, and transition the template to an active state, thereby authorizing it for engagement instantiation. When a HOST signs a staking transfer to an account (e.g., template or engagement) using their private key, they establish authority over that account's hash chain. The HOST can be the primary authorized signer who determines which entries are validated on that chain and executes one or more critical chain-level actions, including creating the genesis entry, staking invites for participants, and signing the final conclusion entry.

The engagement execution engine 205 may receive a request from a HOST entity to instantiate an engagement based on an active template. This requesting HOST entity can be different from the HOST entity who activated the template. The engagement execution engine 205 can validate that the active template is within its absolute expiration of date and time to facilitate an instantiation of a new engagement from the active template. An engagement may be an active instance of the active template including its own specific objectives and participants. The engagement execution engine 205 may obtain the current cryptographic head of the parent template's hash chain to generate a genesis entry that creates the engagement. For example, the engagement execution engine 205 may set the current cryptographic head as a previous hash in the genesis entry to verifiably fork the engagement chain from the template chain at that precise point in time. In some implementations, the engagement execution engine 205 may build the genesis entry using the unique template identifier, current cryptographic head of the template's hash chain, HOST account ID, objectives, engagement stake, and expiration. The engagement execution engine 205 may determine a unique engagement identifier by executing a cryptographic hash function on the genesis entry. The engagement execution engine 205 may use this unique engagement identifier directly as an addressable account identifier of the engagement, allowing the engagement itself to receive and hold cryptographic stakes. The engagement execution engine 205 may receive and process the HOST's authorized signature on the genesis entry, deduct the HOST's initial engagement stake from their holdings, record the HOST as a staker on the engagement, and transition the engagement to an active status by initiating its hash chain and appending the genesis entry to the same. The engagement execution engine 205 may store the engagement instance under templates 226 of the data storage 243. In one example, the data structure of the engagement instance may include a plurality of fields, as shown below:

TABLE 4
Engagement

| | |
|---|---|
| engagement_id | The unique identifier computed from the hash of the |
| (hash) | canonical genesis chain entry. This also serves as the |
| | engagement's account ID, meaning all stakes during |
| | the engagement are transferred to this ID |
| template_id | Identifies which specific Template this engagement |
| (hash) | instantiates |
| host_account_id | The identifier of the HOST whose staking signature |
| (UUID) | established authority over the engagement's hash |
| | chain |
| objectives | The specific goals for this instance of the |
| (string) | engagement. Once created, these objectives are |
| | immutable |
| expiration | A UTC date & time establishing an absolute |
| (ISO 8601 | deadline. After this date, the engagement can no |
| date&time \| | longer be successfully concluded. This value is set in |
| null) | the genesis entry and must not be later than the |
| | expiration date of the underlying Template (if the |
| | Template has one). If left null, the Template's |
| | expiration serves as the effective limit |
| status | The current state of the engagement, which can be |
| (enum) | ‘active,’ ‘concluded,’ or ‘expired’ |
| . | . |
| . | . |
| . | . |

The engagement execution engine 205 can process the invite entry per participant submitted by the HOST entity into the hash chain of the engagement. For example, the invite entry may include a unique account identifier and a role of the participant being invited into the engagement. The engagement execution engine 205 may receive an authorized signature from the HOST entity on the invite entry staking the invite for the participant. This staking action configures the engagement execution engine 205 to deduct the invite stakes from the HOST's account holdings, generate an authentication hash for an authentication code to embed in the invite, record the HOST as a staker on the invite, and communicate the authentication code (e.g., a one-time password) to the invitee through a separate channel (e.g., text message, email, etc.). The engagement execution engine 205 can similarly process the invite entries submitted by an authorized participant and/or by their authorized software agent participating in the engagement on their behalf, the invite entries inviting other participants and/or their authorized software agents to participate in the engagement. Upon receiving an acceptance entry from the invitee, the engagement execution engine 205 may authenticate the participant (e.g., by verifying the participant provided authentication code against the authentication hash) and enforce any predefined role prerequisites, such as making the participant to lock specific qualifying token stakes into the engagement. The engagement execution engine 205 can deduct the required participant credit stakes, update the engagement's active stakers list with the participant, and append the acceptance entry to the hash chain of the engagement.

The engagement execution engine 205 can dynamically evolve the chain state of the engagement by validating and appending post entries submitted by participants to the hash chain, which provide context, status update, progress documentation, other structured data, etc. with authorized signatures from the participants. To initiate engagement termination, the engagement execution engine 205 may process signal entries from one or more accepted participants indicating their agreement to conclude. For example, participants may append a signal entry to agree the engagement objectives are satisfied. The engagement execution engine 205 can cryptographically bind these consensus signals to the exact state of the hash chain at the time of signaling by verifying the current cryptographic head of the hash chain included in the signal entries. Upon determining that the template's specific machine-executable conclusion criteria are satisfied (e.g., sufficient participant signals are validated, etc.) and that the engagement has not expired, the engagement execution engine 205 may process a concluding stake entry (conclusion entry) bearing the HOST's authorized signature. In some implementations, the engagement execution engine 205 may, in an atomic execution, compute and deduct the total aggregated token minting costs from the locked engagement stakes according to the template's token definitions, resolve all remaining locked stakes by redistributing them to participant accounts according to the template's stake transfer rules, and empty the engagement's stakes ledger, transition the engagement status to ‘concluded’, and permanently lock the hash chain of the engagement against further entries. Following the successful conclusion of the engagement, the engagement execution engine 205 may execute a final synchronization step by appending a conclusion record entry directly to the parent template's hash chain, where the entry can be authorized (e.g., cryptographically signed) by the HOST entity. This conclusion record entry can immutably record the unique engagement identifier of the concluded engagement, the conclusion entry hash, and one or more digital tokens minted according to the template's token definition, thereby allowing the system to verify the conclusion status of the specific engagement instance without independently traversing its discrete hash chain. In some implementations, the engagement execution engine 205 can mint one or more digital tokens according to the template's token definition by creating a unique token identifier (e.g., a cryptographic hash of the concatenation of the conclusion entry hash, the recipient account identifier, and an index counter that increments by one for each token minted for the identified engagement) for each token, entering each token identifier as part of the conclusion record entry on the template's hash chain, and crediting each token to the eligible participant's holdings (e.g., listing the token identifier as one of the participant's holdings), where the eligible participant corresponds to the recipient account identifier. The parent template's hash chain provides an easy registry of all engagements instantiated and concluded for that template in this way. In some implementations, the engagement execution engine 205 may record a token melt operation on the template's hash chain in response to a token holder posting a token melt request to the template's hash chain. The template's HOST can review the token melt request and authorize the destruction of the token and transfer the exact par value of the token back to the holder as credits. For example, the token melt operation includes appending an entry on the template's chain signed by the template's HOST, where the entry includes the token identifier, the token holder account id, a hash of the token melt request and amount of credits transferred to the token holder. Upon recording this entry, the engagement execution engine 205 can update the holdings of the token holder account to remove the token (e.g. delete the listing of the token identifier) and add credits equal to or less than the amount of credits required to mint the token (e.g. the par value). The engagement execution engine 205 may store the tokens under tokens 228 of the data storage 243.

The context aggregation engine 207 may include software and/or logic to provide the functionality for managing and surfacing the context associated with templates and engagements. The context may define the interpretive “working information layer” that gives meaning and actionability to the structural elements of templates and engagements. For example, the context may provide the rationale, supporting evidence, guidance, evolving status information, etc. that participants and software agents acting on behalf of the participants can use to pursue the shared objectives of an active engagement. The context may serve primary functions, such as orientation (e.g., providing rationale and background), guidance (e.g., recommending approaches, stages, and criteria to help participants), and shared awareness (e.g., maintaining a common picture of the engagement's status for coordination). The context aggregation engine 207 may aggregate a template context associated with a template authored by a HOST entity. For example, the template context can be authored alongside the template definition by the HOST entity. The template context may surface a rationale outlining the purpose of the engagement type, the problem it addresses, the theory of change, and supporting evidence; a recommended approach offering guidance such as typical stages, assessment criteria for evaluating success, and role-specific expectations; etc. The template context can be distinct from the template's canonical fields (e.g., staking rules, conclusion criteria, token definitions, etc.) that remain immutable and govern the hash corresponding to the unique template identifier. This allows the context aggregation engine 205 to update the template context over time by incorporating lessons gleaned from concluded engagements of that type without changing the underlying template's core identity. The context aggregation engine 207 may store the template context alongside HOST-authored templates under templates 226 of the data storage 243.

The context aggregation engine 207 may create and maintain an engagement context when an engagement is instantiated from an active template. The context aggregation engine 207 can inherit the foundational guidance of the template context to compile the engagement context and further include specific, localized information, such as the engagement's specific objectives (e.g., immutable objectives recorded in the genesis chain entry), participant information (e.g., UUIDs, roles, background, etc.), local circumstances (e.g., timelines, resource availabilities, external dependencies, etc.), etc. As the engagement progresses through a sequence of stages, each stage including interaction and coordination between the participants, the context aggregation engine 207 can continuously update the engagement context to reflect the current state of the engagement by monitoring the chain entries of the engagement. For example, when participants accept invite, the context aggregation engine 207 may update the engagement context to reflect their involvement and information that they may bring. In another example, when participants post status updates, deliverables, observations, and new information relevant to the engagement's objectives in a specific stage of the engagement, the context aggregation engine 207 may evolve the engagement context accordingly. In a different example, when participants signal readiness to conclude engagement, the context aggregation engine 207 may capture this substantive change to reflect in the engagement context. Rather than making the participants reconstruct the engagement's status by reading the entire hash chain, the context aggregation engine 207 can make the engagement context readily available to provide a coherent summary of the up-to-date progression through one or more engagement stages and the status of individual participants relative to them.

The context aggregation engine 207 may separate the engagement context into shared context (public, verified information) and private context (confidential, working information) with a meaningful boundary. The shared context can represent the visible “ground truth” for all participants of the engagement. For example, the shared context may include the template context, engagement-specific details, authorized updates posted to the engagement's hash chain, etc. Because the shared context is anchored to the hash chain and verified by authorized signatures (from HOST, registered participants, other recognized authorities), participants can trust that it cannot be unilaterally altered. The local context can represent a participant's working information that is private by default and not yet posted to the hash chain. For example, the local context may include personal notes, analysis, working documents, information gathered in pursuit of the engagement's objectives, assessments of other participants' contributions or overall engagement trajectory, agent-specific task queues, agent-specific decision logs, agent-specific intermediate results, etc. The context aggregation engine 207 may monitor when participants promote a portion of their local context by formally posting it to the hash chain and transition that portion into the verified, shared context of the engagement. Upon conclusion of an engagement, the corresponding engagement context becomes the final record of how the engagement unfolded. The context aggregation engine 207 can cooperate with the engagement execution engine 205 to use the engagement context of concluded engagements to inform future updates to the parent template's context. The engagement execution engine 205 may store the engagement context under templates 226 of the data storage 243.

The agent coordination engine 209 may include software and/or logic to provide the functionality for facilitating a secure and aligned coordination between multiple agents participating in the structured engagements within the distributed trust network. The use of artificial intelligence is becoming increasingly common for personal assistance, task management, and information processing. For example, users frequently interact with software agents powered by artificial intelligence to manage private information and seek guidance. Concurrently, users may also engage in professional or collaborative relationships with other individuals to achieve shared objectives. However, a user's software agent operates completely independent of the other parties involved in these collaborative relationships. Because the user's software agent operates in isolation, it is difficult or impossible to determine whether the user's interaction with their software agent is aligned with the user's interest or the collaborative support provided by the other parties. In an example of a therapeutic relationship between a healthcare provider and a patient, if the patient uses their own agent, then that agent operates completely independently of the healthcare provider, making it difficult to ensure the agent's advice or guidance aligns with the healthcare provider's treatment plan for the patient. Conversely, if the healthcare provider makes the patient use a provider-controlled agent, then the patient experience is often degraded because the provider-controlled agent is heavily constrained by liability concerns, less engaging for the patient, and lacking access to the patient's private or local data.

The agent coordination engine 209 can resolve this deficiency by bridging the immutable, shared context of the instantiated engagement with the segregated, private data environment of the software agent's interaction with the user and enabling the user to authorize their software agent's participation in the instantiated engagement on their behalf without sacrificing privacy or losing alignment with achieving shared objectives. The agent coordination engine 209 can cooperate with the context monitoring engine 207 to maintain the shared context associated with an instantiated engagement. To securely onboard a user's software agent into the engagement, the agent coordination engine 209 may cooperate with the user interface engine 215 to generate specific user interface (UI) affordances to allow the user to invite their software agent into the instantiated engagement. Upon receiving a request from the user to invite their software agent, the agent coordination engine 209 may generate a prompt to send to the software agent. The agent coordination engine 209 may embed in the prompt: a unique engagement identifier (e.g., a tag identifying the engagement and linking to it) and an authentication code (e.g., one-time password) corresponding to an authentication hash previously locked on the engagement's hash chain. The agent coordination engine 209 can be configured to transmit this prompt directly to a resource identifier (e.g., Uniform Resource Locator (URL)) associated with the user's preferred software agent. Upon receiving the prompt, the invited software agent can utilize the authentication code to cryptographically prove its authority to act on the user's behalf in the engagement and validate itself to the agent coordination engine 209.

Once the user's software agent participates in the engagement on their behalf, the agent coordination engine 209 technically enables the user's software agent is to securely access the shared engagement context via API. Because the shared engagement context is a tamper-proof record tied to the engagement's hash chain, it serves as ground truth for the user's software agent. The shared engagement context provides a machine-readable, verified state of the collaboration that can be continuously polled by authorized software agents. This enables the user's software agent to automatically compare those shared context parameters against data obtained from the user's completely isolated private local context (e.g., a private calendar or local database) visible only to the user and the software agent, and subsequently generate and route authorized update entries back to the hash chain tied to the shared engagement context, all without exposing the underlying private data to the shared engagement context. In the example of the therapeutic relationship between the healthcare provider and the patient, the provider can post the treatment plan, warning signs to monitor, and instructions for regular updates directly into the shared context. The patient's agent may read this exact, up-to-date information and use it to set the parameters for how it interacts with the patient and then post structured updates back to the shared context for the provider (and the provider's own agent) to review. This ensures the patient's software agent remains perfectly aligned with the provider's medical guidance. In another example, if the provider and the patient need to schedule an appointment in one of the stages of the instantiated engagement, the provider's agent can review the provider's private calendar and post a list of available dates to the chain updating the shared context. The patient's software agent may read the shared context, cross-reference those dates against the patient's private calendar, and find a match. The patient's agent posts the confirmed date back to the shared context, and both agents update their users' private calendars. Because the shared context is visible and verified, it enables one's agent to securely coordinate with the other's agent without requiring direct, agent-to-agent communication outside of the engagement.

The agent coordination engine 209 may cooperate with the account staking engine 203 to manage the identity of the user's software agent on the hash chain of the instantiated engagement. The account staking engine 203 can create and maintain a subaccount under a primary account of the user to associate the subaccount with the user's software agent. The user may authorize a public key of the subaccount. For example, the user can use their primary account's private key to sign an entry that designates the subaccount's public key as authorized to act on their behalf in the engagement. This keeps the agent's automated actions clearly distinct from the user's direct actions in the shared engagement context while maintaining a clear chain of direction. In some implementations, the account staking engine 203 can facilitate the user to grant their primary account's private key to their software agent to impersonate them in the engagement. In other implementations, the account staking engine 203 can facilitate the user to create and stake a separate, standalone account for their software agent. The agent coordination engine 209 may store the subaccounts under accounts 224 of the data storage 243.

The hash management engine 211 may include software and/or logic to provide the functionality for facilitating the immutability, sequential integrity, and verifiable authorship of system actions within the distributed trust network. In some implementations, the hash management engine 211 may process all chain entries utilizing a strict canonical serialization format. For example, the hash management engine 211 can execute a canonical JSON serialization protocol comprising recursively sorted object keys (e.g., an RFC 8785-compatible implementation) prior to hashing. The hash management engine 211 then inputs the serialized data into a cryptographic hash function (e.g., SHA-256) to deterministically generate a unique cryptographic identifier for each action. The hash management engine 211 can enforce an append-only data structure by wrapping every action record in a standardized cryptographic envelope. This envelope may comprise a monotonically increasing ‘sequence number’ field and a ‘previous hash’ field. By configuring the hash management engine 211 to inject the precise unique cryptographic identifier of the immediately preceding valid action into the ‘previous hash’ field of a new entry, the hash management engine 211 can cryptographically link the records into an unbroken, tamper-evident sequence extending back to the genesis entry.

In some implementations, the hash management engine 211 may mandate that specific chain entries carry cryptographic proofs of authorship to establish non-repudiation and operational authority. For HOSTs and fully registered participants, the hash management engine 211 can process native digital signatures (e.g., ‘Ed25519’ signatures represented as hex strings) executed over the entry content using the actor's private key. The hash management engine 211 stores this as an ‘authorized signature’ within the entry envelope. For non-registered participants utilizing one-time invites, the hash management engine 211 may validate a secondary authentication mechanism. The hash management engine 211 computes an ‘authentication verification’ token by hashing a combination of an out-of-band ‘authentication code’ and a chain-state binding value (e.g., the cryptographic head of the hash chain), thereby proving the participant's authorization without exposing the raw credential on-chain.

The hash management engine 211 may implement a specialized validation mechanism configured to independently audit the integrity of a requested hash chain. When executing a validation traverse, the hash management engine 211 may walk the chain from the genesis entry to the current head, sequentially performing the following checks: re-computing the canonical hash of the entry content to ensure it matches the stated unique cryptographic identifier, verifying the previous hash matches the verified unique cryptographic identifier of the preceding record, validating the authorized signature cryptographically against the signer's known public key, and for participant-authored entries lacking a direct signature, applying an “implicit validation” rule whereby the entry is deemed valid if a subsequent, descendant entry that incorporates it and carries a valid authorized signature (e.g., HOST's concluding signature) is detected. The hash management engine 211 may store the hash chains under hash chain(s) 232 of the data storage 243.

The exchange analytics engine 213 may include software and/or logic to provide the functionality for distilling the immutable histories recorded for accounts (e.g., user account, templates, engagements, etc.) on the cryptographic hash chains within the distributed trust network into a coherent set of objective measures of trust, reliability, and expected value signals that help participants and HOSTs make informed decisions. The exchange analytics engine 213 can be configured to operate on the guiding principle that trust and value metrics be deterministically derived from cryptographically verified on-chain data (e.g., chain entries, stake transfers, token minting, conclusion records, etc.) rather than being self-reported or assigned by fiat. Furthermore, the exchange analytics engine 213 can be configured to establish a progressive trust baseline, wherein new entities begin with neutral or prior-informed baselines rather than a zero-trust penalty, and metrics dynamically improve as historical data accumulates.

The exchange analytics engine 213 may continuously monitor the state of the distributed trust network to calculate a plurality of metrics. The exchange analytics engine 213 may compute a Success Rate (SR) metric by determining the ratio of successfully concluded engagements to total concluded engagements. The SR metric evaluates the reliability of a given template, user account, or HOST entity. For example, the exchange analytics engine 213 utilizes this metric to rank suggested templates by reliability and to evaluate the competence of inviting HOST entities. The exchange analytics engine 213 can compute a Commitment Depth (CD) metric to measure the economic commitment behind an entity by aggregating the total cryptographic value currently staked on it. For templates and engagements, this metric may represent locked stakes. For accounts, the exchange analytics engine 213 can calculate both outbound CD metric (e.g., stakes placed by the account) and backing CD metric (e.g., stakes placed on the account via ACCOUNT engagements). The CD metric functions as a live, forward-looking signal of commitment. The exchange analytics engine 213 may compute a Token Capital (TC) metric for individual accounts by summing the recoverable credit value (mint cost) of all tokens currently held by the account, thereby quantifying the account's accumulated credential value. This metric provides a verifiable economic floor for earned reputation and can be utilized to evaluate prerequisite qualifications without requiring exact token inspection.

To objectively measure collaborative value creation, the exchange analytics engine 213 may calculate an Engagement Yield (EY) metric. The exchange analytics engine 213 computes EY as the average net value created per concluded engagement determined by calculating the ratio of total value distributed back to participants (including both returned stakes and the minted value of awarded tokens) relative to the initial total value staked by those participants. Because HOSTs, third-party donors, and token melt values add to the payout, participants can receive more value than they put in. This metric provides a positive-sum measurement of value generation that is conceptually analogous to a price signal in a zero-sum transaction market, where a higher EY indicates greater value creation for all participants. For example, a high EY metric attracts participants, while rising EY metric signals that an engagement is well-funded.

To evaluate the topology of trust within the distributed trust network, the exchange analytics engine 213 may compute one or more specific relational metrics. The exchange analytics engine 213 computes a Backing Breadth (BB) metric to measure the diversity of an account's trust sources. This can be calculated using a logarithmic function of the total backing stake multiplied by the number of independent backing HOSTs, thereby capturing the significant leap in trust that occurs when an account secures multiple independent backers. The exchange analytics engine 213 calculates a relational metric called Social Proximity (SP) between any pair of accounts by executing a weighted sum over their shared backing HOSTs, co-participations in concluded engagements, and shared templates. This metric helps users gauge familiarity and reduce perceived risk when interacting with new parties. The exchange analytics engine 213 further calculates an Engagement Momentum (EM) score using a time-weighted sum of recent engagement conclusions. The exchange analytics engine 213 applies a decay factor to this calculation such that recent successful conclusions contribute significantly more to the EM score than distant historical conclusions, effectively surfacing trending templates and actively participating accounts and ensuring dormant accounts or templates naturally decay in visibility.

To optimize computational resources and provide actionable data, the exchange analytics engine 213 may utilize a multi-tiered execution architecture. Monotonically updating metrics (e.g., SR, CD, TC, and EY) can be computed automatically at the time an entry is processed and maintained within a status cache, whereas time-aware relational metrics (e.g., SP and EM) get computed lazily on demand. For example, instead of recalculating everything from scratch, this status cache keeps running totals of on-chain data, such as success counts, participant inputs/outputs, active backing lists, etc. and updating the running totals automatically when a new stake or conclusion entry is processed.

The exchange analytics engine 213 may implement a dynamic routing module configured to aggregate the individual metrics into normalized composite scores for specific decision-making scenarios. The exchange analytics engine 213 combines the normalized SR, normalized EY, normalized EM, and normalized CD parameters to calculate Template Attractiveness Score (TAS), which can be used to rank templates in marketplace discovery. The exchange analytics engine 213 combines the normalized template SR, normalized HOST SR, normalized SP, and normalized EY parameters to calculate Invite Confidence Score (ICS), which can be used to help a participant decide whether an incoming invite is worthwhile to accept. The exchange analytics engine 213 combines the normalized account SR, normalized BB, normalized TC, normalized EM, and normalized SP parameters to calculate Participant Suitability Score (PSS), which can be used to rank candidates for engagement invitations and help a HOST decide which accounts to stake an invite or prioritize. The exchange analytics engine 213 can facilitate the invite tags to include individual and composite metrics of the inviter or the invite itself before they are sent to participants via the engagement exchange platform. Furthermore, the invite tags can be fundamentally different from standard referral codes because they are secure invites backed by verifiable stakes put up by the inviter. When an inviter sends an invite tag via the engagement exchange platform, they commit a digital stake that is locked into the engagement which the invitee can confirm. The inviter cannot recover this stake until the engagement successfully concludes, ensuring that inviters only invite parties they genuinely believe to be able to succeed. The exchange analytics engine 213 can track the expiration date on the invite tag sent out to a participant. If the invite is not timely accepted by the participant, the exchange analytics engine 213 can unlock and revert the stakes back to the inviter's account. If the exchange analytics engine 213 detects the invitee declined the invite, then the stakes are similarly unlocked and reverted to the inviter's account.

The exchange analytics engine 213 may solve the “cold start” problem associated with new accounts and templates with no history to score by cooperating with the user interface engine 215 to generate specific display strategies. For example, the exchange analytics engine 213 can prominently display a new template's structural rules (e.g., its staking requirements, token definitions, etc.) so users can evaluate it manually, tag the new template as “Early”, and/or allow them to inherit the proxy reputation of their backing HOST until they build enough history to generate a score. The exchange analytics engine 213 can further be configured to execute specialized value distribution patterns upon engagement conclusion. The exchange analytics engine 213 can allow third-party donor accounts (e.g., non-governmental organizations, charitable trust, health initiatives, etc.) to stake engagements as registered stakeholders on behalf of participants. Upon successful conclusion, the exchange analytics engine 213 can allocate the donor stakes to active participants and provide the donor with a verifiable impact signal proving their funds directly contributed to a successful outcome, all without requiring their participation in the engagement itself.

For specific template categories, the exchange analytics engine 213 may generate a “bonus pool” comprising stakes forfeited from unsuccessfully concluded engagements to incentivize success. Upon the expiration date of the template, the exchange analytics engine 213 may automatically redistribute the stakes from this “bonus pool” to the accounts associated with successfully concluded engagements of the same template type. The share of stakes can be allocated either equally or proportionally to the initial amounts stake by the accounts. In some implementations, the exchange analytics engine 213 may automatically burn the stakes from unsuccessfully concluded engagements to increase the overall value of remaining credits. The exchange analytics engine 213 may store the computed trust and reliability metrics under metrics 234 of the data storage 243.

The user interface engine 215 may include software and/or logic for providing user interfaces to a user. In some implementations, the user interface engine 215 receives instructions from one or more of the components 201, 203, 205, 207, 209, 211, and 213, generates a user interface according to the instructions, and transmits the user interface for display on the client device 115 as described herein. In some implementations, the user interface engine 215 sends graphical user interface data to an application (e.g., a browser) in the client device 115 via the communication unit 241 causing the application to display the data as a graphical user interface.

FIGS. 3A-3E illustrate graphical representations of example user interfaces for navigating one or more engagements on a secure engagement exchange platform. FIG. 3A is a graphical representation of an example user interface 300 illustrating a home page of the secure engagement exchange platform. In FIG. 3A, the user interface 300 includes a main dashboard 302. The main dashboard 302 comprises a navigation menu providing access to systemic views such as “Dashboard,” “Engagements,” “Holdings,” “Invites,” and “Discover”. The user interface 300 is structurally divided into a plurality of functional panes: engagement directory pane 304 and active engagement view 306. The engagement directory pane 304 is a lateral pane (e.g., a left sidebar) displaying a categorized list of the user's engagements, listed by current programmatic status, comprising “Invitations” (1 pending), “Active,” (2 active) and “Concluded” (0 concluded) engagements. Upon selection of a specific active engagement 308 (e.g., “Concert Ready-Engagement 1: Symphony Spring Concert”) from the engagement directory pane 304, the active engagement view 306 area populates with the canonical details of the selected engagement. The active engagement view 306 comprises a header section 310 displaying the engagement name, current status (e.g., “Active”), and the immutable objectives 312; a tabbed navigation array 314 allowing the user to toggle between different views of the engagement data, comprising “Context,” “Participants,” “Stakes,” and “Timeline” tabs; a cryptographic posting interface 316 comprising input fields for a “Message,” an optional “Subject,” and an optional “Stake (credits)” amount, alongside a “Post” button configured to append a new entry to the engagement's hash chain and update the engagement context; and a chronological feed 318 displaying the verified shared engagement context.

FIG. 3B is a graphical representation of an example user interface 320 illustrating a transition from the example user interface 300 of FIG. 3A in response to the user selecting the engagement invitation 322 (e.g., “Caregiver Coaching: Supporting Diane and her Father”) on the engagement directory pane 304. The active engagement view 306 area populates with the invitation details of the engagement invitation. The active engagement view 306 comprises a header section 324 displaying the engagement name the user is being invited to, current status (e.g., “Invitation”), the immutable objectives 326, the invitation details 328 with a role of “Friend” with “Accept Invitation” button 330 and “View Full Details” button 332.

FIG. 3C is a graphical representation of an example user interface 340 illustrating the active engagement 342 (e.g., “Run your first 5K: Liza's Edgewook 5K”) from the engagement directory pane 304 being selected by the user. In FIG. 3C, the user interface 360 indicates that the user has accepted the engagement invitation 322 in FIG. 3B because it is now “Active” on the engagement directory pane 304. Upon selection of a specific active engagement 342 from the engagement directory pane 304, the active engagement view 306 area populates with the context details of the selected engagement. The active engagement view 306 further includes a plurality of primary action triggers (e.g., selectable buttons), notably including a “Signal Conclusion” trigger 344 and a dedicated “Talk To My Agent” integration trigger 346.

FIG. 3D is a graphical representation of an example user interface 360 illustrating the active engagement 342 (e.g., “Run your first 5K: Liza's Edgewook 5K”) from the engagement directory pane 304 with the user activating the “Stakes” tab 364 on the tabbed navigation array 362. Upon selection of the “Stakes” tab 364 on the tabbed navigation array 362, the active engagement view 366 area populates with the “Current Stakes” indicating the amount of credits staked by the “Host Alpha” on the engagement.

FIG. 3E is a graphical representation of an example user interface 380 illustrating a secondary interface, such as a modal overlay or dialog box, titled “Talk to your Agent” upon the user activating the “Talk To My Agent” trigger 368 from the active engagement view 366 in FIG. 3D. The user interface 380 is specifically configured to facilitate the secure transfer of cryptographic context to a software agent of user's choosing. The user interface 380 includes a designated text box 382 displaying a pre-compiled, machine-readable payload (i.e., the “Prompt”). The user interface 380 instructs the user to copy and paste this payload into their preferred software agent interface. This generated prompt embeds the specific Uniform Resource Locator (URL) locator for the engagement context (e.g., https://xbtag.com/E/f64b . . . ) and authentication code (e.g., SECRET_AGENT_OTPx) necessary for the software agent to cryptographically authenticate itself to the distributed trust network. In the user interface 380, the text box 382 includes a plurality of selectable UI elements 384 (e.g., buttons labeled “AI Agent 1,” “AI Agent 2,” “AI Agent 3”) configured to open the corresponding third-party agent environments in a new browser window or application instance. To enable continuous, asynchronous multi-agent coordination, the text box 382 further comprises a data entry field labeled “paste the session URL” 386. This field instructs the user to input the specific URL of the newly created agent session. The text box 382 includes a “Save Session URL” trigger 388, which configures the system to persistently map the user's specific engagement account to that external active agent session for future direct routing.

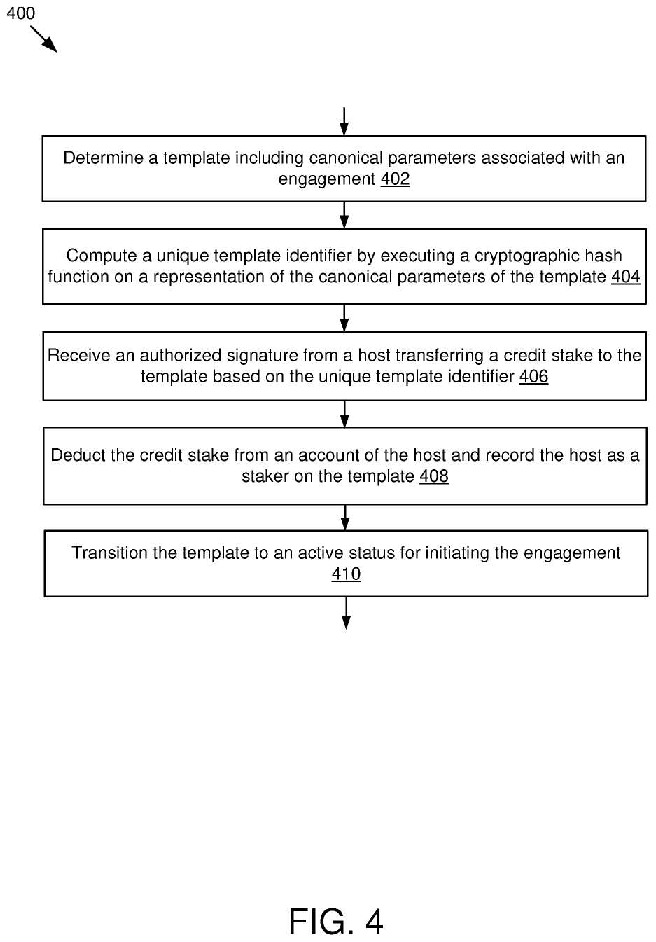

FIG. 4 is a flow diagram illustrating one implementation of an example method 400 for staking a digital credit on a template. The method 400 may be a sequence of operations or process steps performed by a system of one or more computing devices in one or more locations, including, for example, the secure engagement exchange server 110, the registry server 120, and the client device 115 of FIG. 1, or any combinations thereof. Moreover, while in some implementations, the sequence of operations may be fully automated, in other implementations some steps may be performed and/or guided through human intervention. Furthermore, it will be appreciated that the order of operations in the sequence may be varied, and that some operations may be performed in parallel and/or iteratively in some implementations.

At 402, the engagement execution engine 205 determines a template including canonical parameters associated with an engagement. At 404, the engagement execution engine 205 computes a unique template identifier by executing a cryptographic hash function on a representation of the canonical parameters of the template. At 406, the engagement execution engine 205 receives an authorized signature from a HOST transferring a credit stake to the template based on the unique template identifier. At 408, the engagement execution engine 205 deducts the credit stake from an account of the HOST and record the HOST as a staker on the template. At 410, the engagement execution engine 205 transitions the template to an active status for initiating the engagement.

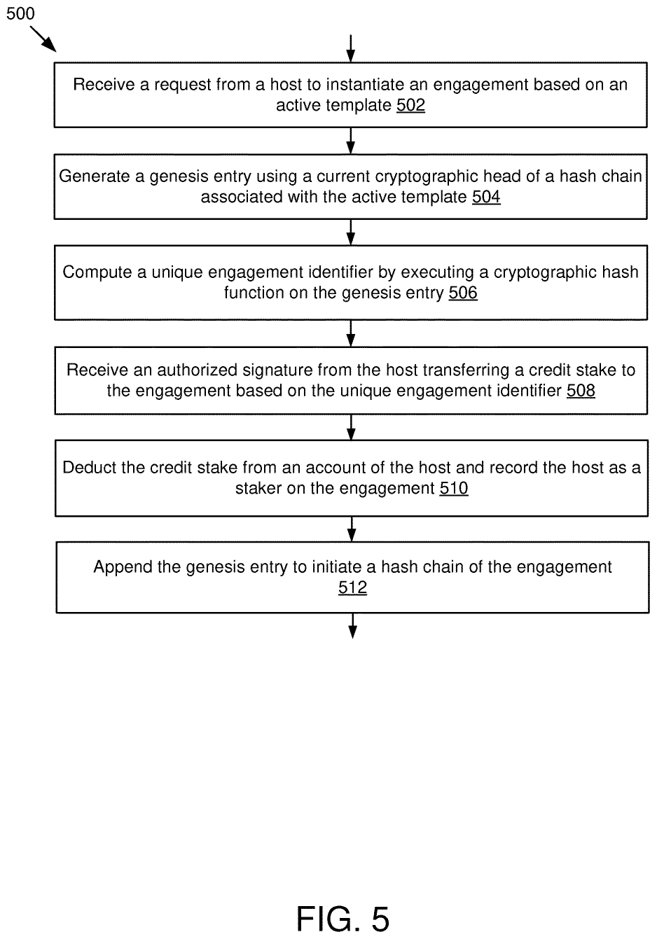

FIG. 5 is a flow diagram illustrating one implementation of an example method 500 for staking a digital credit on an engagement from a template. The method 500 may be a sequence of operations or process steps performed by a system of one or more computing devices in one or more locations, including, for example, the secure engagement exchange server 110, the registry server 120, and the client device 115 of FIG. 1, or any combinations thereof. Moreover, while in some implementations, the sequence of operations may be fully automated, in other implementations some steps may be performed and/or guided through human intervention. Furthermore, it will be appreciated that the order of operations in the sequence may be varied, and that some operations may be performed in parallel and/or iteratively in some implementations.

At 502, the engagement execution engine 205 receives a request from a HOST to instantiate an engagement based on an active template. At 504, the engagement execution engine 205 generates a genesis entry using a current cryptographic head of a hash chain associated with the active template. At 506, the engagement execution engine 205 computes a unique engagement identifier by executing a cryptographic hash function on the genesis entry. At 508, the engagement execution engine 205 receives an authorized signature from the host transferring a credit stake to the engagement based on the unique engagement identifier. At 510, the engagement execution engine 205 deducts the credit stake from an account of the host and record the host as a staker on the engagement. At 512, the engagement execution engine 205 appends the genesis entry to initiate a hash chain of the engagement.

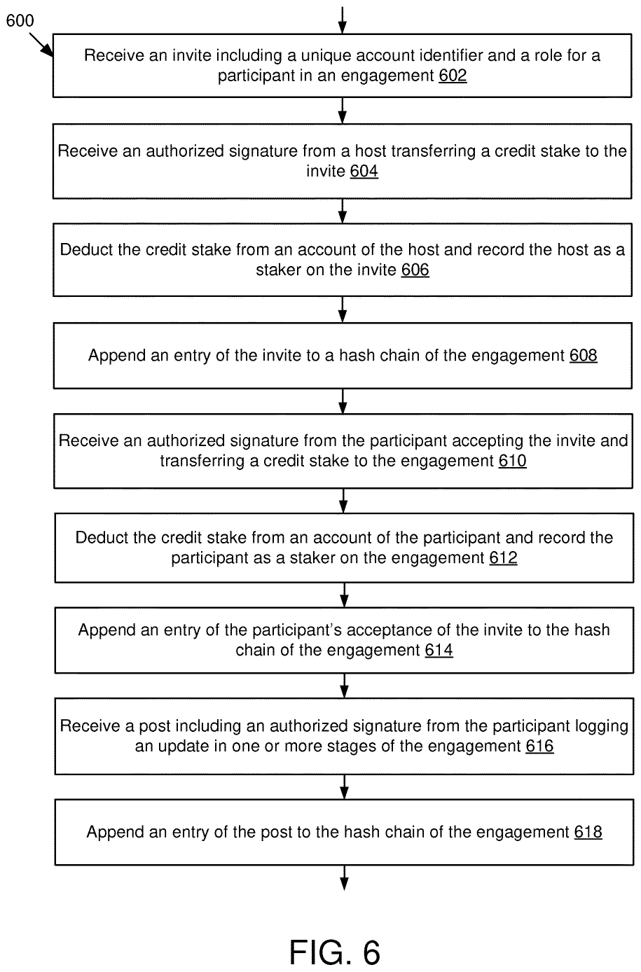

FIG. 6 is a flow diagram illustrating one implementation of an example method 600 for staking a digital credit on an invite to an engagement. The method 600 may be a sequence of operations or process steps performed by a system of one or more computing devices in one or more locations, including, for example, the secure engagement exchange server 110, the registry server 120, and the client device 115 of FIG. 1, or any combinations thereof. Moreover, while in some implementations, the sequence of operations may be fully automated, in other implementations some steps may be performed and/or guided through human intervention. Furthermore, it will be appreciated that the order of operations in the sequence may be varied, and that some operations may be performed in parallel and/or iteratively in some implementations.

At 602, the engagement execution engine 205 receives an invite including a unique account identifier and a role for a participant in an engagement. At 604, the engagement execution engine 205 receives an authorized signature from a host transferring a credit stake to the invite. At 606, the engagement execution engine 205 deducts the credit stake from an account of the host and record the host as a staker on the invite. At 608, the engagement execution engine 205 appends an entry of the invite to a hash chain of the engagement. At 610, the engagement execution engine 205 receives an authorized signature from the participant accepting the invite and transferring a credit stake to the engagement. At 612, the engagement execution engine 205 deducts the credit stake from an account of the participant and record the participant as a staker on the engagement. At 614, the engagement execution engine 205 appends an entry of the participant's acceptance of the invite to the hash chain of the engagement. At 616, the engagement execution engine 205 receives a post including an authorized signature from the participant logging an update in one or more stages of the engagement. At 618, the engagement execution engine 205 appends an entry of the post to the hash chain of the engagement.

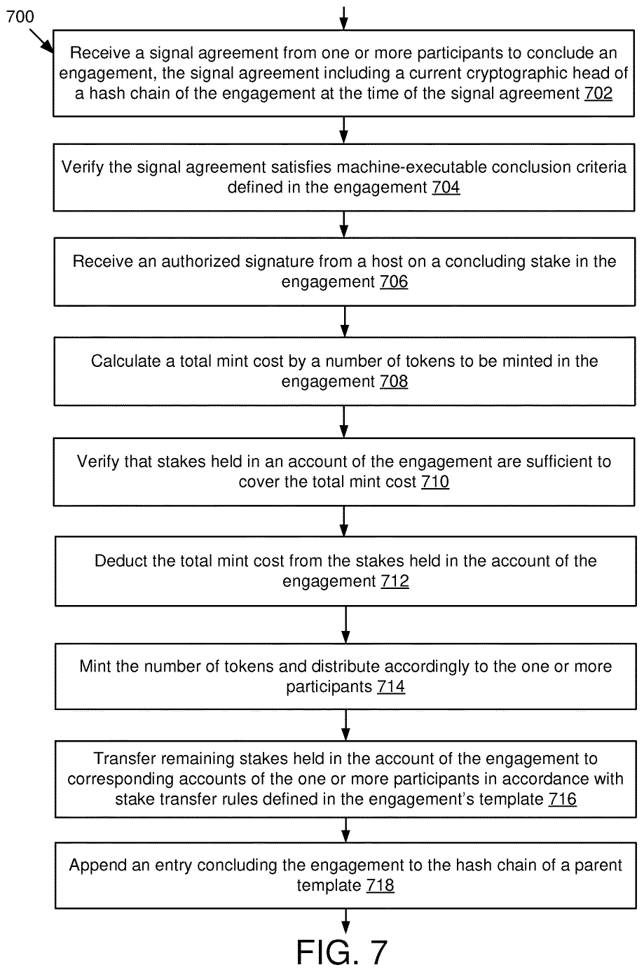

FIG. 7 is a flow diagram illustrating one implementation of an example method 700 for concluding an engagement. The method 700 may be a sequence of operations or process steps performed by a system of one or more computing devices in one or more locations, including, for example, the secure engagement exchange server 110, the registry server 120, and the client device 115 of FIG. 1, or any combinations thereof. Moreover, while in some implementations, the sequence of operations may be fully automated, in other implementations some steps may be performed and/or guided through human intervention. Furthermore, it will be appreciated that the order of operations in the sequence may be varied, and that some operations may be performed in parallel and/or iteratively in some implementations.

At 702, the engagement execution engine 205 receives a signal agreement from one or more participants to conclude an engagement, the signal agreement including a current cryptographic head of a hash chain of the engagement at the time of the signal agreement. At 704, the engagement execution engine 205 verifies the signal agreement satisfies machine-executable conclusion criteria defined in the engagement. At 706, the engagement execution engine 205 receives an authorized signature from a host on a concluding stake in the engagement. At 708, the engagement execution engine 205 calculates a total mint cost by a number of tokens to be minted in the engagement. At 710, the engagement execution engine 205 verifies that stakes held in an account of the engagement are sufficient to cover the total mint cost. At 712, the engagement execution engine 205 deducts the total mint cost from the stakes held in the account of the engagement. At 714, the engagement execution engine 205 mints the number of tokens and distribute accordingly to the one or more participants. At 716, the engagement execution engine 205 transfers remaining stakes held in the account of the engagement to corresponding accounts of the one or more participants in accordance with stake transfer rules defined in the engagement's template. At 718, the engagement execution engine 205 appends an entry concluding the engagement to the hash chain of a parent template.

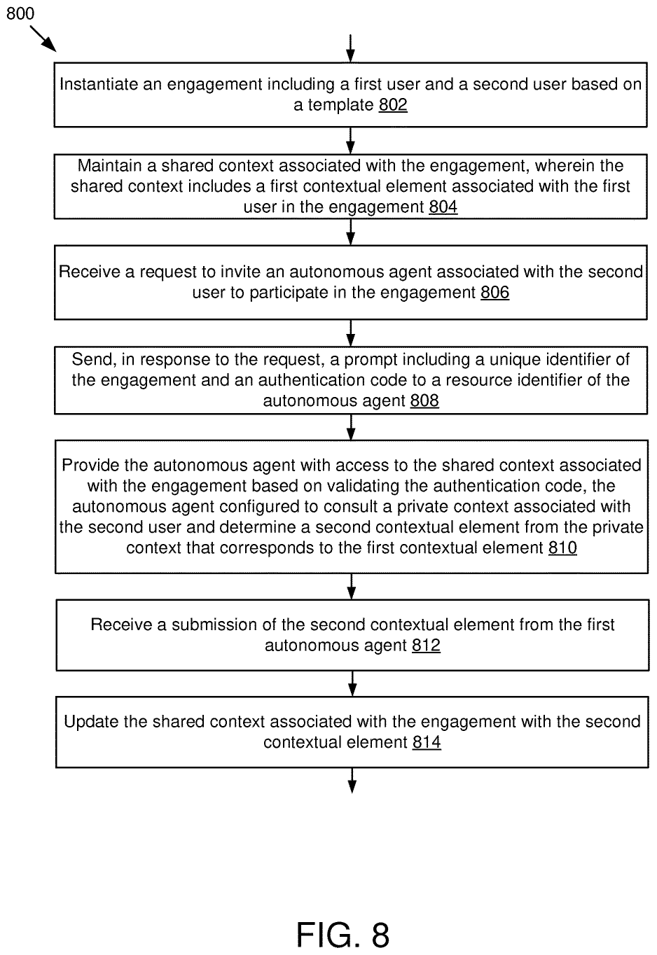

FIG. 8 is a flow diagram illustrating one implementation of an example method 800 for coordinating with an autonomous agent in an engagement. The method 800 may be a sequence of operations or process steps performed by a system of one or more computing devices in one or more locations, including, for example, the secure engagement exchange server 110, the registry server 120, and the client device 115 of FIG. 1, or any combinations thereof. Moreover, while in some implementations, the sequence of operations may be fully automated, in other implementations some steps may be performed and/or guided through human intervention. Furthermore, it will be appreciated that the order of operations in the sequence may be varied, and that some operations may be performed in parallel and/or iteratively in some implementations.

At 802, the engagement execution engine 205 instantiates an engagement including a first user and a second user based on a template. At 804, the context monitoring engine 207 maintains a shared context associated with the engagement, wherein the shared context includes a first contextual element associated with the first user in the engagement. At 806, the agent coordination engine 209 receives a request to invite an autonomous agent associated with the second user to participate in the engagement. At 808, the agent coordination engine 209 sends, in response to the request, a prompt including a unique identifier of the engagement and an authentication code to a resource identifier of the autonomous agent. At 810, the agent coordination engine 209 provides the autonomous agent with access to the shared context associated with the engagement based on validating the authentication code, the autonomous agent configured to consult a private context associated with the second user and determine a second contextual element from the private context that corresponds to the first contextual element. At 812, the agent coordination engine 209 receives a submission of the second contextual element from the first autonomous agent. At 814, the agent coordination engine 209 updates the shared context associated with the engagement with the second contextual element.

A system and method for implementing a cryptographic mechanism for managing and coordinating collaborative structured engagements involving multiple participants. In the above description, for purposes of explanation, numerous specific details are set forth in order to provide a thorough understanding of the techniques introduced above. It will be apparent, however, to one skilled in the art that the techniques can be practiced without these specific details. In other instances, structures and devices are shown in block diagram form in order to avoid obscuring the description and for ease of understanding. For example, the techniques are described in one implementation above primarily with reference to software and particular hardware. However, the present invention applies to any type of computing system that can receive data and commands, and present information as part of any peripheral devices providing services.

Reference in the specification to “one implementation” or “an implementation” means that a particular feature, structure, or characteristic described in connection with the implementation is included in at least one implementation. The appearances of the phrase “in one implementation” in various places in the specification are not necessarily all referring to the same implementation.

Some portions of the detailed descriptions described above are presented in terms of algorithms and symbolic representations of operations on data bits within a computer memory. These algorithmic descriptions and representations are, in some circumstances, used by those skilled in the data processing arts to convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing”, “computing”, “calculating”, “determining”, “displaying”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The techniques also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but is not limited to, any type of disk including floppy disks, optical disks, CD-ROMs, and magnetic disks, read-only memories (ROMs), random access memories (RAMs), EPROMS, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description of the embodiments has been presented for the purposes of illustration and description. It is not intended to be exhaustive or to limit the specification to the precise form disclosed. Many modifications and variations are possible in light of the above teaching. It is intended that the scope of the embodiments be limited not by this detailed description, but rather by the claims of this application. As will be understood by those familiar with the art, the examples may be embodied in other specific forms without departing from the spirit or essential characteristics thereof. Likewise, the particular naming and division of the modules, routines, features, attributes, methodologies and other aspects are not mandatory or significant, and the mechanisms that implement the description or its features may have different names, divisions and/or formats. Furthermore, as will be apparent to one of ordinary skill in the relevant art, the modules, routines, features, attributes, methodologies and other aspects of the specification can be implemented as software, hardware, firmware or any combination of the three. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the specification is in no way limited to embodiment in any specific programming language, or for any specific operating system or environment. Accordingly, the disclosure is intended to be illustrative, but not limiting, of the scope of the specification, which is set forth in the following claims.

What is claimed is:

1. A computer-implemented method comprising:
instantiating an engagement including a first user and a second user based on a template;
maintaining a shared context associated with the engagement, wherein the shared context includes a first contextual element associated with the first user in the engagement;
receiving a request to invite a first autonomous agent associated with the second user to participate in the engagement;
sending, in response to the request, a prompt including a unique identifier of the engagement and a first authentication code to a resource identifier of the first autonomous agent;
providing the first autonomous agent with access to the shared context associated with the engagement based on validating the first authentication code, the first autonomous agent configured to consult a private context associated with the second user and determine a second contextual element from the private context that corresponds to the first contextual element;
receiving a submission of the second contextual element from the first autonomous agent; and
updating the shared context associated with the engagement with the second contextual element.

2. The computer-implemented method of claim 1, further comprising:
creating a subaccount associated with the first autonomous agent under an account of the second user;
authorizing a public key of the subaccount associated with the first autonomous agent using a private key of the account of the second user to participate in the engagement on behalf of the second user; and
receiving the submission of the second contextual element from the first autonomous agent through an authorized signature of the first autonomous agent.

3. The computer-implemented method of claim 1, further comprising:
receiving a request to invite a second autonomous agent associated with the first user to participate in the engagement;
sending, in response to the request, a prompt including the unique identifier of the engagement and a second authentication code to a resource identifier of the second autonomous agent; and
providing the second autonomous agent with access to the shared context associated with the engagement based on validating the second authentication code, the second autonomous agent configured to consult a private context associated with the first user to determine the first contextual element.

4. The computer-implemented method of claim 3, wherein:
the first contextual element is generated based on an interaction between the first user and the second autonomous agent in the private context associated with the first user, and
the second contextual element is generated based on an interaction between the second user and the first autonomous agent in the private context associated with the second user.

5. The computer-implemented method of claim 1, further comprising:
receiving a request from the first user to instantiate the engagement based on the template;
generating a genesis entry using a current cryptographic head of an independent hash chain associated with the template;
computing the unique identifier of the engagement by executing a cryptographic hash function on the genesis entry; and
initiating an independent hash chain associated with the engagement by appending the genesis entry.

6. The computer-implemented method of claim 5, further comprising:
receiving a first digital stake from an account of the first user to the unique identifier of the engagement; and
receiving a second digital stake from an account of the second user to the unique identifier of the engagement, where the first digital stake and the second digital stake serve as an enforcement mechanism for participation in the engagement and remain locked until the engagement transitions to a concluded state.

7. The computer-implemented method of claim 6, further comprising:
receiving a submission of an authorized entry to the independent hash chain associated with the engagement from the first autonomous agent associated with the second user, the authorized entry indicating a readiness to conclude the engagement;
verifying the authorized entry satisfies machine-executable conclusion criteria defined by the engagement;
determining a mint cost associated with a token to be minted in the engagement;
verifying that a sum of the first digital stake and the second digital stake is sufficient to cover the mint cost;
minting the token by deducting the mint cost from an account of the engagement;
distributing the token to the second user for participation in the engagement; and
transferring a remainder of the sum of the first digital stake and the second digital stake to one or more of the first user and the second user.

8. The computer-implemented method of claim 1, wherein the private context associated with the second user is inaccessible to the shared context associated with the engagement and the first user.

9. The computer-implemented method of claim 1, wherein an update to the shared context associated with the engagement corresponds to an entry cryptographically posted to an independent hash chain associated with the engagement.

10. The computer-implemented method of claim 1, wherein:
the first user is a healthcare professional;
the second user is a patient member; and
the engagement corresponds to a sequence of interactions between the first user and the second user in a healthcare intervention.

11. A system comprising one or more processors and a memory operably coupled with the one or more processors, wherein the memory stores instructions that, in response to execution of the instructions by the one or more processors, cause the one or more processors to perform operations including:
instantiating an engagement including a first user and a second user based on a template;
maintaining a shared context associated with the engagement, wherein the shared context includes a first contextual element associated with the first user in the engagement;
receiving a request to invite a first autonomous agent associated with the second user to participate in the engagement;
sending, in response to the request, a prompt including a unique identifier of the engagement and a first authentication code to a resource identifier of the first autonomous agent;
providing the first autonomous agent with access to the shared context associated with the engagement based on validating the first authentication code, the first autonomous agent configured to consult a private context associated with the second user and determine a second contextual element from the private context that corresponds to the first contextual element;
receiving a submission of the second contextual element from the first autonomous agent; and
updating the shared context associated with the engagement with the second contextual element.

12. The system of claim 11, wherein the operations further comprise:
creating a subaccount associated with the first autonomous agent under an account of the second user;
authorizing a public key of the subaccount associated with the first autonomous agent using a private key of the account of the second user to participate in the engagement on behalf of the second user; and
receiving the submission of the second contextual element from the first autonomous agent through an authorized signature of the first autonomous agent.

13. The system of claim 11, wherein the operations further comprise:
receiving a request to invite a second autonomous agent associated with the first user to participate in the engagement;
sending, in response to the request, a prompt including the unique identifier of the engagement and a second authentication code to a resource identifier of the second autonomous agent; and
providing the second autonomous agent with access to the shared context associated with the engagement based on validating the second authentication code, the second autonomous agent configured to consult a private context associated with the first user to determine the first contextual element.

14. The system of claim 13, wherein:
the first contextual element is generated based on an interaction between the first user and the second autonomous agent in the private context associated with the first user, and
the second contextual element is generated based on an interaction between the second user and the first autonomous agent in the private context associated with the second user.

15. The system of claim 11, wherein the operations further comprise:
receiving a request from the first user to instantiate the engagement based on the template;
generating a genesis entry using a current cryptographic head of an independent hash chain associated with the template;
computing the unique identifier of the engagement by executing a cryptographic hash function on the genesis entry; and
initiating an independent hash chain associated with the engagement by appending the genesis entry.

16. The system of claim 15, wherein the operations further comprise:
receiving a first digital stake from an account of the first user to the unique identifier of the engagement; and
receiving a second digital stake from an account of the second user to the unique identifier of the engagement, where the first digital stake and the second digital stake serve as an enforcement mechanism for participation in the engagement and remain locked until the engagement transitions to a concluded state.

17. The system of claim 16, wherein the operations further comprise:
receiving a submission of an authorized entry to the independent hash chain associated with the engagement from the first autonomous agent associated with the second user, the authorized entry indicating a readiness to conclude the engagement;
verifying the authorized entry satisfies machine-executable conclusion criteria defined by the engagement;
determining a mint cost associated with a token to be minted in the engagement;
verifying that a sum of the first digital stake and the second digital stake is sufficient to cover the mint cost;
minting the token by deducting the mint cost from an account of the engagement;
distributing the token to the second user for participation in the engagement; and
transferring a remainder of the sum of the first digital stake and the second digital stake to one or more of the first user and the second user.

18. The system of claim 11, wherein the private context associated with the second user is inaccessible to the shared context associated with the engagement and the first user.

19. The system of claim 11, wherein an update to the shared context associated with the engagement corresponds to an entry cryptographically posted to an independent hash chain associated with the engagement.

20. The system of claim 11, wherein:
the first user is a healthcare professional;
the second user is a patient member; and
the engagement corresponds to a sequence of interactions between the first user and the second user in a healthcare intervention.
